(19) United States
(12) Patent Application Publication
(10) Pub. No.: US 2026/0253856 A1
(43) Pub. Date: Aug. 27, 2026

(54) Mass Spectrometry System and Methods

(71) Applicant: Steam Instruments, Inc., Madison, WI (US)

(72) Inventors: Igor V Veryovkin, Darien, IL (US); John A. Hunt, Pacific Grove, CA (US)

(21) Appl. No.: 19/064,271

(22) Filed: Feb. 26, 2025

(51) Int. Cl. H01J 49/06

(52) U.S. Cl. CPC H01J 49/061

(57) ABSTRACT

Mass spectrometry systems and methods comprise a pulsed ion prism that operates to deflect a plurality of sample ions having a desired range of mass-to-charge ratios towards a detector. The prism comprises a pair of deflection electrodes spaced apart by a defined spatial gap and, when the deflection electrodes are energized, an electric field created in the vicinity of the defined spatial gap is operative to deflect sample ions away from an initial path onto plural deflected paths. An ion extraction module initiates the creation of ions from a specimen using a brief, pulsed extraction, the liberated sample ions thereafter accelerating along an initial path towards the prism where a plurality of sample ions are deflected with a plurality of deflection angles, the deflection angles being proportional to the mass-to-charge ratio. Desired ranges of mass-to-charge ratios may be selected and detected with high mass resolving power.

### REFERENCE TO RELATED APPLICATIONS

Not Applicable.

### FEDERALLY SPONSORED RESEARCH AND DEVELOPMENT

Not Applicable.

### DESCRIPTION OF ATTACHED APPENDIX

Not Applicable.

### BACKGROUND OF THE INVENTION

Advances in the field of mass spectrometry (MS) are the focus of the present disclosure. MS techniques are used in both research and associated commercial development in a wide range of fields, such as: chemistry; biology; medicine; virology; pharmacology; ecology; environmental science; physics; and other fields. Consequently, improvements in MS systems, methods, and apparatus are highly desirable.

The field of mass spectrometry is concerned with measuring the mass of particles. Those particles may be atoms, molecules, ions, biological materials such as RNA sequences, DNA sequences, and more. Oftentimes the end goal of mass spectrometry is to determine the atomic constituents, in both identity and proportion, of the particles or molecules under test. Analytical techniques in mass spectrometry typically involve the action of voltage gradients, light illumination, heating, and other means, to liberate minute portions, or samples, of a specimen under test, those particles thereafter being formed into a flow of charged particles whose properties, including particle mass and particle mass-to-charge ratio, may then be measured. It is common that the liberated sample particles are a heterogeneous mixture of ions and neutrals and, consequently comprise many different atomic and molecular species. Moreover, even sample particles of the same atomic or molecular species may be present with differing charge states and one or more constituent atoms may be present in more than one isotope. Thus, the practical use of MS presents many difficulties, and consequently, improvements through novel systems, methods, and apparatus are valuable and highly desirable.

### SUMMARY OF THE INVENTION

The present disclosure is directed to systems, methods, and apparatus that are useful in the field of mass spectrometry. Exemplary embodiments of the present disclosure describe improved systems that are able to measure mass spectra from specimen materials. Furthermore, embodiments of the present disclosure describe systems and methods that are improvements over the conventional mass spectrometry techniques known in the art. In particular, the present disclosure describes systems and methods that enable improvements in the areas of: measuring mass spectra from large ion masses that are difficult or even impossible to measure with typical MS techniques; selecting ranges of ion masses to be directed towards a detector effective for measuring large masses; directing ions with a selected range of masses towards additional stages for further operations and eventual MS analysis; and, directing ions with a selected range of masses towards a sample collection system.

Embodiments of the present disclosure describe mass spectrometry systems, methods, and apparatuses that are effective for measuring mass spectra data of ionized atomic species, ionized molecules, and ionized biological specimens with mass-to-charge ratios of up to and beyond 700 mega-Daltons (MDa), where one Dalton (1 Da) is roughly equal to the mass of one proton. For reference, biologically relevant molecules may include, but are not limited to: Water (18 Da); Glucose (180 Da); Adenosine Triphosphate (507 Da); Hemoglobin(~64500 Da); typical antibody AgI (~0.15 MDa); DNA Polymerase 1 (~0.9 MDa); Ribosome fromE. coli (~2.5 MDa); Titin (the largest known protein) (~3 MDa); Polio virus (~5.5 MDa); Human immunodeficiency virus (12-15 MDa); Tobacco mosaic virus (~40 MDa); Adenovirus (~150 MDa); SARS-CoV-2 (200-300 MDa).

A typical mass spectrometry system of the present disclosure comprises the following components operating in a vacuum chamber: an ion extraction module operable to provide controlled extraction, from a specimen, of specimen ions for analysis, said controlled extraction starting at an extraction time, thereby creating a plurality of extracted sample ions; a controllable ion beam element, hereinafter referred to as an angular dispersion prism or pulsed ion prism, that receives at least a portion of said sample ions, the prism providing a configurable dispersion of the ions in angle to the flight path of said portion of said sample ions, thereby producing a plurality of deflected ions; and, a detector operable to detect at least a portion of said deflected ions, the detector being further operable to measure the time-of-arrival of the detected ions. In systems of the present disclosure, the prism is operative to create a distribution of deflection angles in which the magnitude of deflection angle of an ion is related to its mass-to-charge property. Furthermore, in systems of the present disclosure, the operation of the prism is configurable to provide a separation in angle of deflection for ions within a desired range of mass-to-charge ratios. Creating a distribution of deflection angles may be referred to as creating a dispersion relation in the deflection angles induced into sample ions by the action of the prism. Consequently, systems of the present disclosure that induce a deflection angle on a plurality of ions in which the magnitude of the angle is in relation to the mass-to-charge ratio of the ions may be referred to as an angular dispersion prism, pulsed ion prism, or simply prism.

In some embodiments, system elements or stages that affect one or more properties of the flow of ions and/or that separate the flow of ions into one or more sub-flows of ions with different properties, may be added to the system to receive deflected ions and subject those ions to further operations before relaying a portion of those ions to a downstream component of the system. Such systems may be composed by chaining mass spectrometry stages together such that the ions output by a first stage are relayed to a following stage as input ions to the following stage, said following stage may, in turn, output ions that are relayed to yet another stage. In some embodiments, one or more stages or system elements may operate on the flow of ions received from an ion extraction module, ion injection module, or ion alteration module and may thereafter relay ions to one or more pulsed ion prisms. In like manner, some embodiments may configure one or more ion stages or system elements to operate on the flow of ions received from the prism and may thereafter relay the affected ions to downstream stages, elements, or detectors. In some embodiments, the said stages may include additional prisms.

In some embodiments, a selection aperture is disposed in the flight path of at least a portion of the deflected ions; the selection aperture being operable to block the flight path of a portion of said deflected ions, thereby allowing a plurality of selected ions to pass beyond said selection aperture; a portion of the selected ions eventually arriving at a detector operable to detect at least a portion of said selected ions. A detector may be operable to measure a property of the ion flux such as the time-of-arrival of said detected ions or the total charge accumulated in a given time. The effect of the selection aperture in these embodiments is to restrict the ions reaching the detector, further refining the system's ability to measure ions in a range of interest. Furthermore, a selection aperture may restrict the ion flux to a desired narrow range of mass-to-charge ratio or may restrict the energy spread of the ion flux.

In some embodiments, a stage may be added to receive a portion of deflected ions, acting on that portion of ions to improve mass resolving power, thereafter relaying ions to a detector. In some embodiments, a time-of-flight mass analyzer may be used to operate on a flow of sample ions and thereby improve the mass resolving power of the system. In other embodiments, stages improving mass resolving power of the system can be combined with stages for manipulating ions, thereby affecting the mass or charge state of the manipulated ions.

In some embodiments the detector may detect other properties of the detected ions. In some embodiments a Faraday cup detector or an array of such detectors may be used to detect the charge on detected ions. In some embodiments, a micro-channel plate (MCP) may be used to detect the ions and determine their time of arrival. In some embodiments, MCP-based detectors may include conversion dynodes at their receiving ends to further extend the detectable range of mass-to-charge ratios. In some embodiments, MCP-based detectors may be equipped at their outputs with multiple independent ion collectors (including, but not limited to, delay line anodes) to enable laterally resolved position-sensitive ion detection. In some embodiments, a position-sensitive areal detector such as a charge-coupled device (CCD) or a hybrid metal-oxide semiconductor (CMOS)/CCD ion detector or detector array may be used to detect ion currents. In some embodiments a superconducting detector (SC) may be used to detect the energy of detected ions. In some embodiments, said SC detectors may be capable of position-sensitive ion detection.

In some embodiments, ion mobility, which can be measured by the time that ions drift through a gas cell, may be detected. Ions with increased interactions with the gas molecules will proportionally reduce their speed, and the resultant distribution of speeds can be used to subsequently select molecules by their spatial or chemical properties.

Ion extraction modules of the present disclosure may comprise: a specimen holder, which may be coupled to a positioning stage; a plurality of extraction electrodes; a multichannel high voltage source operable to apply configurable voltages on said specimen holder and on each of said plurality of extraction electrodes; a configurable laser source disposed to emit laser light that illuminates a desired portion of the specimen; and, an ion extraction controller that coordinates the application of voltages and laser illumination to extract ions from the specimen.

Ion extraction modules of the present disclosure may comprise a plurality of mechanical, electrical, optical, and ion-optical components necessary for the generation of pulses of sample ions that subsequently enter a pulsed ion prism for m/z analysis. The components forming a source of discrete packets of ions (ion pulses) may include, but are not limited to:
a. An ion optical system converting a continuous ion stream into pulses of ions, including, but not limited to, an ion gate (typically used in ion mobility spectrometry), orthogonal acceleration ion optics (typically used in time-of-flight mass spectrometry), or said pulsed ion prism;
b. An ion source capable of generating sample ions from a solid, liquid or gaseous specimen. Such ion sources may be based on interactions of energetic particles, including but not limited to ions, photons and electrons, or electric field, with a specimen. These interactions may include, but not limited to, laser ablation and desorption, ion sputtering, electron stimulated desorption, laser photoionization (post-ionization), electron impact ionization, electrospray ionization, surface (thermal) ionization, electric field evaporation, and others. Gaseous samples may be produced from solid or liquid samples by one type of said interactions, while ionization is enabled by the same or a different type of these interactions; and,
c. Other components including, but not limited to, a specimen holder, which may be coupled to a positioning stage; a plurality of ion-optical electrodes; a multichannel high voltage power supply operable to apply configurable voltages on said specimen holder and on each of said plurality of the electrodes, and, an ion extraction controller that coordinates the application of voltages and the process of ion formation from the specimen.

In some embodiments of the present disclosure, the ion extraction controller is operable to create pulsed high voltage and pulsed laser illumination, either singly or in combination to extract ions from a specimen. High voltage may be applied to said extraction electrodes in continuous or pulsed operation and may be synchronized in time and/or duration with a defined time schedule and may be operated in coordination with other elements and operations of the mass spectrometry system. In addition, laser illumination may be applied to said specimen in continuous or pulsed operation and may be synchronized in time and/or duration with a defined schedule and may be operated in coordination with other elements and operations of the mass spectrometry system.

Pulses of sample ions are relayed downstream by their momentum and may be further affected by the action of any intervening ion optics and/or electric fields. At least a portion of said sample ions eventually reach a pulsed ion prism. When energized, the prism is effective for deflecting ions away from their original flight path by a deflection angle which may be different for different ions. The magnitude of the deflection angle imposed on any particular sample ion may be affected by: the mass-to-charge ratio of each ion; the timing with which the prism is energized and de-energized; the magnitudes and polarities of voltages used to energize the prism; the time course or schedule of voltages applied to the deflection electrodes; the shape and configuration of the electrodes comprising the prism; and more. The deflection angle can be understood as a deflection of an ion from its original flight path, with the result that an ion may be described as having a direction of flight that is different from its original flight path, the difference defining a deflection angle, as a consequence of the pulsed ion prism′ effect on the motion of the ion. In preferred embodiments, for at least a portion of said sample ions, the magnitude of the deflection angle of a deflected ion is related to its mass-to-charge ratio (m/z). It can be understood from the foregoing description that pulsed ion prisms, in preferred embodiments of the present disclosure, may deflect ions by means of electric fields dynamically created and shaped by electrodes and voltages applied to those electrodes. As such, pulsed ion prisms of the present disclosure can be understood as pulsed electric-field angular dispersion prisms. Furthermore, techniques using such prisms may be referred to as Angle-of-Flight Mass Spectrometry (AOFMS).

In preferred embodiments of the present disclosure, a pulsed ion prism comprises: a plurality of deflection electrodes; a multichannel high voltage source under the control of a deflection controller, said multi-channel high voltage source being operable to apply configurable voltages on each of said plurality of deflection electrodes; an ion entry region that is effective for receiving at least a portion of the sample ions produced by the ion extraction module, a deflection region in which ions are deflected by an electric field, or deflection field, created by said plurality of deflection electrodes; an ion exit region for deflected ions; and, an ion exit region for undeflected ions produced when the prism is in a quiescent or de-energized state. Under the control of said deflection controller, configurable high voltages may be applied to said deflection electrodes in continuous or pulsed operation and may be synchronized in time and/or duration with a defined time schedule and may be operated in coordination with other elements and operations of the mass spectrometry system. In preferred embodiments, the deflection controller provides: a quiescent or de-energized mode of operation in which a portion of the sample ions travels through the prism in a straight path; and, an energized or deflecting mode of operation in which the prism is operative to deflect at least a portion of said sample ions according to a known relationship between the magnitude of deflection angle and the mass-to-charge ratio of individual ions thereby producing a plurality of deflected ions. The effect of the energized prism is to induce on the plurality of deflected ions a distribution in deflection angle as a function of the mass-to-charge ratio of the ions entering the ion entry region. Pulsed operation of the energized prism is a preferred mode of operation of the system in which the timing of the energizing pulse to the prism is according to a defined schedule with respect to the extraction of sample ions from the specimen.

Embodiments of the present disclosure address a number or areas of mass spectroscopy over which the need for improvement has long been felt. Problems solved by the present embodiments include, but are not limited to:
A. Restructuring a pulsed linear ion beam into an angular dispersion of ions having the characteristic that direction of flight of ions within the angular dispersion is in a known relationship with m/z ratio of each ion;
B. Decreased (or eliminated) lensing effects while creating angular dispersion;
C. Under computer control, the ability to electronically select a range of ion m/z to be dispersed;
D. Under computer control, the ability to electronically control the amount of angular dispersion of ions;
E. Ability to use the same apparatus to analyze sample ions with very low m/z (e.g., 1), or with very high m/z (e.g., hundreds of megaDaltons)
F. Under computer control, the ability to electronically select and direct ions of a specified range of m/z to a specific detector, ion collector, or subsequent analysis system;
G. The generic case of analyzing any time-organized stream of ions and:
   a. Restructuring a pulsed linear ion beam into an angular dispersion of ions having the characteristic that direction of flight of ions within the angular dispersion is in a known relationship with the time-organization of the stream of ions, for instance, creating an angular dispersion of ion mobility from ions exiting an ion mobility cell;
   b. Under computer control, the ability to electronically select and direct ions of a specified range of time to a specific detector, ion collector, or subsequent analysis system.

The foregoing advantages are achieved by embodiments of the present disclosure by the combined effects of:
A. Design, configuration, and operation of a plurality of electrodes operating as a pulsed ion prism on a structured flow or pulse of sample ions;
B. Energizing said pulsed ion prism to create a dynamic electric field, said energizing done according to a defined schedule with respect to the creation of sample ions;
C. Operating said dynamic electric field so as to induce a controllable m/z dependency in the deflection angle of ions affected by the pulsed ion prism, using said controllability to select m/z fractions and/or m/z ranges for relay to detector stages of the system;
D. Further sub-selecting fractions of m/z by use of one or more configurable selection apertures;
E. Producing the angular dispersion of ions with limited or negligible lensing aberration by use of certain planar surfaces on one or more deflection electrodes;
F. Limiting undesirable signal loss and/or mass resolution power loss by minimizing or lowering lensing aberrations inherent in prior designs that use curved or rounded electrode shapes;
G. Detecting sample ions at one or more detectors that are sensitive to the time of arrival and to the position of arrival, the position of arrival adding to the selectivity of the system with respect to fine distinctions between different m/z fractions.

In some embodiments of the present disclosure, deflected ions are relayed downstream where at least a portion of the deflected ions are detected by a detector. In some embodiments the detector may register the arrival time of individual ions thereby facilitating time-of-flight measurements. In some embodiments the detector may register the location on the detector where an ion has been detected. In other embodiments of the present disclosure, the detector may be configured to either count the arrival of ions at the detector, or, to measure the total current produced by the arrival of ions at the detector accumulated over a time period. Data from the detector along with engineering and calibration data enable the measurement of the mass-to-charge ratio of individual ions reaching the detector. Accumulation of such data enables characterizing the mixture of ions liberated from the specimen thereby producing mass-to-charge ratio spectrum or a mass spectrum for the material constituents of the specimen.

In some embodiments, deflected ions are relayed downstream where at least a portion of the deflected ions reach a selection aperture. In preferred embodiments the selection aperture comprises a configurable width and position, whereby at least a portion of said deflected ions pass through said selection aperture and continue to travel downstream toward a detector. Deflected ions not passing through said selection aperture do not travel downstream toward the detector. The selection aperture may be disposed with respect to the prism so that the selection aperture is effective for selecting ions having a desired range of mass-to-charge ratio while stopping ions outside of that range.

In light of the foregoing commentary, it is clear that embodiments of the present disclosure provide improved apparatuses and methods and, consequently, are highly desirable.

### BRIEF DESCRIPTION OF THE DRAWINGS

These and other features, aspects, and advantages of the present invention will become better understood with regard to the following description, appended claims, and accompanying drawings where:

FIG. 1 shows a schematic view of mass spectrometry system;

FIG. 2 shows a perspective view of an embodiment of a first deflection electrode for use in a pulsed ion prism according to the embodiment of FIG. 1;

FIG. 3 shows a front elevation view of a first deflection electrode;

FIG. 4 shows a rear elevation view of first deflection electrode;

FIG. 5 shows a perspective view of an embodiment of a second deflection electrode for use in a pulsed ion prism;

FIG. 6 shows a rear elevation view of second deflection electrode;

FIG. 7 shows a graphical representation of a defined schedule for operating a pulsed ion prism;

FIG. 8 shows a schematic view of mass spectrometry system;

FIG. 9 shows an ion selection stage having a fixed selection aperture;

FIG. 10 shows a cross section of the apparatus of FIG. 9;

FIG. 11 shows an ion selection stage having a configurable selection aperture;

FIG. 12 shows a cross section of the apparatus of FIG. 11;

FIG. 13 shows an ion selection stage having a configurable selection aperture;

FIG. 14 shows a cross section of the apparatus of FIG. 13;

FIG. 15 shows an ion selection stage having a configurable selection aperture;

FIG. 16 shows a cross section of the apparatus of FIG. 15;

FIG. 17 shows a schematic view of an ion extraction module for use with various embodiments of the present disclosure;

FIG. 18 shows a graphical representation of a defined schedule for operating a mass spectrometry system according to an embodiment of the disclosure;

FIG. 19 shows a cross section view of a practical embodiment of deflection electrodes for use in a pulsed ion prism;

FIG. 20 shows a cross section view of a non-pulsed ion prism in which all ions are deflected through about the same angle;

FIG. 21 shows a top-down plan view of a pulsed ion prism and the simulated deflected trajectories of ions having a range of mass-to-charge-number ratios from about 800,000 to about 1,200,000;

FIG. 22 shows a top-down plan view of a pulsed ion prism and the simulated deflected trajectories of ions having a range of mass-to-charge-number ratios from about 80,000,000 to about 120,000,000;

FIG. 23 shows a graph of time of flight versus mass to charge number ratio useful for calibrating exemplary mass spectrometry instruments of the present disclosure;

FIG. 24 shows statically deflected time-of-flight data sampled from a micro-channel plate (MCP) detector;

FIG. 25 shows a graph of experimental data from a calibrated pulsed ion prism system, the data having been calibrated for accurate m/z measurement of ion species from a sample;

FIGS. 26, 27, and 28 show graphs depicting mass spectra obtained from a realized embodiment of an angle-of-flight mass spectrometry (AOFMS) system according to the teachings of the present disclosure;

FIGS. 29 and 30 are graphs demonstrating mass resolving power versus higher mass resolving power of different configurations of exemplary mass spectrometry instruments of the present disclosure.

FIG. 31 shows an alternate embodiment of second deflection electrode which has physical features that are complementary to the first deflection electrode.

FIG. 32 shows a schematic view of mass spectrometry system operable to collect a selected range of m/z ions from a specimen on a collection surface.

### LIST OF REFERENCE NUMBERS APPEARING IN THE FIGURES

1—mass spectrometry system
10—ion extraction module
11—specimen
12—specimen holder
14—positioning stage
16—extraction electrode
16a, 16b, . . . first extraction electrode, second extraction electrode, . . .
18—communication channel
20—multi-channel high voltage source
21—applied voltage
21a, 21b, . . . —first voltage, second voltage, . . .
22—ion extraction controller
24—laser source
25—laser light
26—plurality of sample ions
27—initial path of ions
28—plurality of non-deflected ions
30—pulsed ion prism
31—elongate electrode body
32—deflection controller
34—multi-channel high voltage source
35—voltage
35a, 35b, . . . —first voltage, second voltage, . . .
36—deflection electrode
36a, 36b, . . . first deflection electrode, second deflection electrode, . . .
37—spatial gap
38—planar inner surface of electrode
38a, 38b, . . . —first planar inner surface of electrode, second planar inner surface of electrode, . . .
39—planar boundary surface of electrode
39a, 39b, . . . —first planar boundary surface of electrode, second planar boundary surface of electrode, etc.
40—deflected ion
40a, 40b, . . . —first deflected ion, second deflected ion, . . .
41—sample ion entry region
42—deflected ion exit region
43—deflected ion flight path
44—deflection angle
45—non-deflected ion exit region
46—attachment flange
46a, 46b, . . . first attachment flange, second attachment flange, . . .
47—plurality of non-deflected ions
50—selection stage
52—selection aperture
53—selection aperture width
54—adjustable selection aperture
55—adjustable aperture blade
55a, 55b, . . . —first adjustable aperture blade, second adjustable aperture blade, . . .
56—selected ion
56a, 56b, . . . —first selected ion, second selected ion, . . .
58—angular dispersion
60—ion detector
64—sample collection surface
70—defined schedule
TD1—time at deflection controller switches to energized mode
TD2—time at which deflection controller switched to de-energized mode
TE—time at which ion extraction begins
TL—time at which laser pulse is initiated
T1—time corresponding to a first peak in ion detection
T2—time corresponding to a second peak in ion detection
200—graphical plot of TD1 versus a range of m/z values
201—graphical plot of TD2 versus a range of m/z values
202—graphical plot of arrival time at detector versus a range of m/z values
240—plot of signal strength vs. time of flight for data acquired by MCP detector
260—plot of mass spectrum obtained by embodiment of the present disclosure
270—plot of mass spectrum obtained by embodiment of the present disclosure
280—plot of mass spectrum obtained by embodiment of the present disclosure

### DESCRIPTION

Various embodiments of the present invention are now described with reference to the drawings, wherein like reference numerals are used to refer to like elements throughout. In the following description, for purposes of explanation, numerous specific details are set forth in order to provide a thorough understanding of the present invention. It may be evident, however, that the present invention can be practiced without these specific details. In other instances, well-known structures and devices may be shown in block diagram form in order to facilitate the description of the present invention.

Certain elements of the present disclosure deal with apparatus and methods for creating, working with, and guiding the trajectory of charged particles, or ions. A flowing plurality of charged ions may be referred to as an ion flux, or an ion current, or an ion beam. A flowing plurality of ions may also have a finite extent in space as a pulse or packet configuration having a shape, pulse width, and other collective physical properties. An ion flux may comprise a heterogeneous mixture of constituent ions having a range of masses, charges, and mass-to-charge ratios. Various elements and methods are described that enable the emission, control, and shaping of ion currents, beams, and pulses. In some instances, portions of the embodiments may be referred to as lenses or as ion optics. It can be understood then that the lenses or ion optics referred to in this disclosure are used to control the trajectories of ions and various properties of those ion currents, beams, and pulses.

Certain elements of the present disclosure are described as electrodes. Electrodes of the present disclosure have a conductive or resistive outer surface wherein an electric potential applied to one portion of an electrode has the effect of energizing the whole electrode at the same or substantially the same electric potential. Furthermore, each electrode may be energized to a range of voltages that includes zero volts as referenced to the local ground potential, positive voltages, and negative voltages. A multichannel high voltage power supply, or equivalent, may be used to supply the variety of different voltages to the various electrodes described hereinafter in the embodiments.

High voltages may be applied continuously or applied in pulses and may have a defined sequence in both time and voltage. High voltage power supplies may be based upon a number of different conventional technologies such as solid state or vacuum tube and may be driven by AC or DC input voltages. A multichannel high voltage power supply may supply a variable high voltage to one or more channels, and it may supply those voltages in defined voltage sequences and/or with defined timing relationships between changes in voltage as well. In addition, a multichannel high voltage power supply may supply a voltage at or near the local ground potential on one or more channels. Also, a multichannel high voltage power supply may be operative to maintain defined voltage differences between pairs of output channels as well as controlled variable voltage differences between pairs of output channels. Furthermore, in some embodiments voltages may be controllable and/or programmable with respect to one or more of the following properties, voltage polarity, voltage magnitude, changes in voltage magnitude, time of onset of applied voltage, slew rate or rise time of applied voltage changes, dwell time of applied voltage, and fall time of applied voltage changes.

Certain elements of the present disclosure may be referred to as a controller. Generally, a controller may be understood as a real component that orchestrates actions and sequences of actions taken to accomplish the overall goal of the system or apparatus. Controllers of the present disclosure may comprise processing, memory, stored programs, stored parameterized programs, communications, input, output, and timing functions necessary to receive inputs and/or communications, and in response produce outputs and/or communications that enable the controlled operation of the various modules, systems, and sub-systems that they control. Controllers of the present disclosure may also be configurable in that they allow setting and resetting of various parameters, programs, and timings used by the controller in its operations. In the art, a computer may be understood to be an embodiment of a controller. Furthermore, controllers of the present disclosure may communicate with other elements, through one or more communication channels, to accomplish the overall function of the systems, components, and methods of the present disclosure. Communications channels may be embodied by the means and methods known in the art and include electrical hardware signaling, opto-electrical hardware signaling, over-the-air electromagnetic signaling such as radio, WiFi, Bluetooth, Near-Field Communication (NFC), and may use defined software protocols layered on top of said electrical hardware. Furthermore, such communication between elements can be one directional, such as receiving a sensor reading or outputting a defined voltage level, or bidirectional such as sending and receiving command, control, and status information to and from the connected modules, systems, and sub-systems with which they communicate.

The field of mass spectrometry is concerned with determining the mass of the various charged particles that are liberated from the specimen under test, the masses being denoted in customary units of mass, whether those units be kilograms, Daltons, or other units. The present disclosure uses the mass units of Daltons (Da), kilo-Daltons (kDa) and mega-Daltons (MDa), however, a person of ordinary skill in the art can recognize that any unit of mass may be used to describe the same physical property of mass. The present disclosure also uses the unitless “mass number” (m) of an ion, which represents the total number of heavy particles (protons and neutrons jointly called nucleons) in the atomic nucleus. It should be readily apparent that an ion's mass divided by one Dalton is equivalent to its mass number.

In arriving at determinations of mass, the systems and methods of the present disclosure describe various ways of working with ionized particles, wherein the magnitude of charge on each ionized particle must be equivalent to an integer multiple of the charge on a single electron. It is clear that an ionized particle, regardless of whether it is positively or negatively charged must have a magnitude of charge that is equivalent to an integer number of electrons. This integer number of electron charges in the present disclosure is denoted with the letter ‘z’ and is also known as the unitless “charge number”. Since ionized particles have both a charge number and a mass number, it is conventional in the field of mass spectrometry to make determinations of mass-to-charge ratio, which may be denoted as the unitless quantity m/z and can be calculated by dividing the particle's mass number by its charge number. Sometimes the term “mass-to-charge number ratio” may be used in place of “mass-to-charge ratio” to further clarify that m/z is a unitless quantity, although it should be readily apparent that these two terms have identical meaning.

It can be understood then that by measuring the m/z ratio of a sample particle, by means of the systems and methods of the present disclosure, a determination of the actual mass of the particle may be made if the charge number is known. When the actual charge number is not known, the actual mass determination may be made to within an integer multiple. Often in the practice of mass spectrometry, the charge number is not directly measured but instead determined using various approaches combining experimental measurements and reference data.

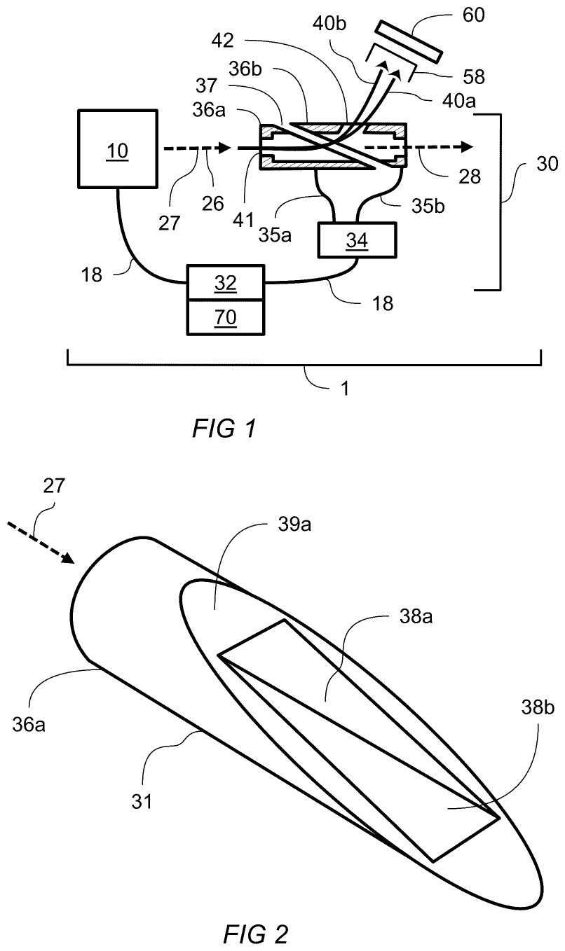

Turning now to the figures, FIG. 1 shows a schematic view of mass spectrometry system 1 according to a preferred embodiment of the disclosure. Mass spectrometry system 1 of FIG. 1 comprises: ion extraction module 10 configured as a source of ion pulses from a specimen thereby creating sample ions, thereafter an electric field accelerates at least a portion of said sample ions thereby creating a plurality of extracted sample ions 26 having a range of mass-to-charge ratios and traveling along initial path 27; a pulsed ion prism 30 receiving at least a portion of said plurality of sample ions through sample ion entry region 41, said pulsed ion prism 30 operating on said plurality of sample ions to create a plurality of deflected ions, 40a and 40b, which exit said pulsed ion prism 30 through a deflected ion exit region 42, said plurality of deflected ions traveling towards detector 60, detector 60 being disposed to receive and detect at least a portion of said plurality of deflected ions thereby defining a plurality of detected ions, detector 60 being further operative to record arrival times of said plurality of detected ions and other data such as ion positions, ion charge, etc., that may be useful in the determination of mass-to-charge ratios for said plurality of detected ions.

With continuing reference to FIG. 1, each deflected ion exiting through said deflected ion exit region 42 may be characterized as having acquired a deflection angle through the action of said pulsed ion prism 30 in which the deflection angle is in a proportional relationship with the mass-to-charge ratio of each deflected ion, said proportional relationship being further characterized in that smaller mass-to-charge ratio ions are deflected less with respect to said initial path than larger mass-to-charge ratio ions. Consequently, a first deflected ion 40a, having a smaller mass-to-charge ratio, will exit the deflected ion exit region with a smaller deflection angle (with respect to said initial path), and a second deflected ion 40b, having a larger mass-to-charge ratio, will exit the deflected ion exit region with a larger deflection angle. In preferred embodiments, the pulsed ion prism 30 may be operated so that only a portion of sample ions will become deflected ions, the remainder thereby becoming a plurality of non-deflected ions 28 which may exit the pulsed ion prism 30 through a non-deflected ion exit region.

Continuing with FIG. 1, pulsed ion prism 30 is effective for inducing an angular dispersion 58 in the plurality of deflected ions that is in relation to the mass-to-charge ratio for each deflected ion. Pulsed ion prism 30 comprises: a first deflection electrode 36a that receives at least a portion of the extracted sample ions through sample ion entry region 41; a second deflection electrode 36b that is disposed to maintain spatial gap 37 between said first and said second deflection electrode, at least a portion of said spatial gap extending in a direction that is non-orthogonal to said initial path, said second deflection electrode 36b comprising a deflected ion exit region 42. Both deflection electrodes 36a and 36b are operatively connected to multi-channel high voltage source 34 to supply configurable first voltage 35a to said first deflection electrode 36a, and to supply configurable second voltage 35b to said second deflection electrode 36b. When first voltage 35a is not equal to second voltage 35b, an electric field is created in the immediate vicinity of said spatial gap that is operative to deflect the paths of ions that traverse any portion of said electric field. Deflection controller 32 is in communication with both ion extraction module 10 and multi-channel high voltage source 34 through communication channels 18 and is thereby operative to coordinate ion extraction operation with operation of pulsed ion prism 30.

In preferred embodiments, ion extraction module 10 is operated to produce a pulse of sample ions from the specimen, whereafter said ion extraction module 10 accelerates said sample ions using an electric field which imparts an acceleration to each ion in proportion to the charge-to-mass ratio of each ion. An equivalent statement is that the acceleration imparted to each ion is inversely proportional to mass-to-charge ratio. Ions exiting the ion extraction module may thereby be structured in time such that ions with the lowest mass-to-charge ratio emerge from ion extraction module 10 first, the remainder of ions present in the pulse of sample ions being ordered according to their mass-to-charge ratio, with the highest mass-to-charge ratio ions exiting the ion extraction module last. It is understood in the art that the ordering of ions leaving an ion extraction module is not perfect due to certain sources of variability such as: sample ions do not all come from exactly the same point on the specimen; sample ions do not all leave the specimen at exactly the same time; sample ions do not all travel exactly the same path through the extraction module; sample ions do not all travel exactly the same path length before exiting the extraction module; the electric field that accelerates the sample ions may not be perfectly uniform with respect to each sample ion, and other sources of variation. These variations in combination work to create a distribution in space of any ion species having a particular mass-to-charge ratio. Exemplary embodiments of ion extraction modules seek to reduce variability in the ordering of extracted sample ions leaving said ion extraction module.

Continuing with FIG. 1, deflection controller 32 may operate according to defined schedule 70, which specifies the time course and magnitude of first voltage 35a and second voltage 35b, in coordination with the commencement of sample ion extraction provided by ion extraction module 10. Deflection controller 32 may be further configured to provide: an energized mode in which said first voltage is different from said second voltage; a de-energized mode in which said first voltage is about equal to said second voltage; and to switch from said de-energized mode to said energized mode according to defined schedule 70. Deflection controller 32 may thereby operate the pulsed ion prism 30 so that a desired subset of sample ions is deflected, which effectively enables the selection and deflection of a subset of the range of mass-to-charge ratio ions present in the plurality of extracted sample ions. Said desired subset of sample ions may be selected by adjusting the timing of the operation of the pulsed ion prism to match the arrival of said desired subset of sample ions to the vicinity of the spatial gap. Deflection of said desired subset of sample ions may be accomplished by pulsing, at a time corresponding to the arrival of the desired subset of sample ions in the vicinity of said spatial gap, a voltage differential between first voltage 35a and second voltage 35b, which thereby energizes said first and said second deflection electrodes 36a and 36b, creating an electric field for the duration of the pulsed voltage differential. It is clear from the foregoing description that defined schedule 70 may be adjusted to select any subset of mass-to-charge ratio ions present in the plurality of sample ions.

Turning now to FIG. 2, shown is a perspective view of an embodiment of a first deflection electrode 36a for use in a pulsed ion prism. First deflection electrode 36a is shown comprising: elongate electrode body 31 extending in the direction of initial path 27 along which sample ions may travel; a first planar inner surface 38a extending parallel to said initial path 27; a second planar inner surface 38b extending parallel to said initial path 27; said first and second planar inner surfaces intersecting at about a 90 degree angle; both first and second planar inner surfaces being part of a plurality of adjoining inner surfaces that create an open conduit suitable for ions to travel through without impediment; a first planar boundary surface 39a that is disposed at a non-90 degree angle with respect to said initial path, said first planar boundary surface terminating the plurality of inner boundary surfaces.

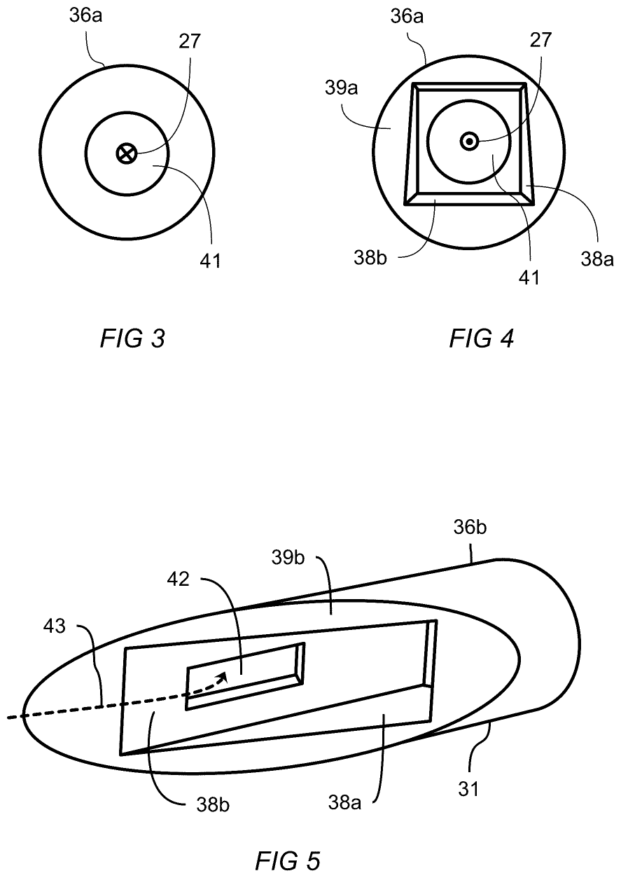

FIG. 3 shows a front elevation view of first deflection electrode 36a according to FIG. 2. This view is shown looking in the direction of the initial path 27 with sample ion entry region 41 shown in this embodiment as a round aperture. A plurality of sample ions passes through said sample ion entry region, traveling in the direction of the initial path, and are thereafter available to be influenced by the operation of the pulsed ion prism.

FIG. 4 shows a rear elevation view of first deflection electrode 36a according to FIG. 2. This view is shown looking in the direction opposite to initial path 27. A plurality of sample ions passes through sample ion entry region 41 while traveling along said initial path 27. A plurality of adjoining planar inner surfaces is shown in the figure, including first planar inner surface 38a and second planar inner surface 38b, creating a conduit through which the plurality of sample ions may pass. In preferred embodiments, the plurality of planar inner surfaces may create a conduit having a rectangular or square cross section, the conduit being formed by the combination of two pairs of parallel sides. First planar boundary surface 39a is shown in this view as a planar feature disposed at a non-orthogonal angle with respect to initial path 27.

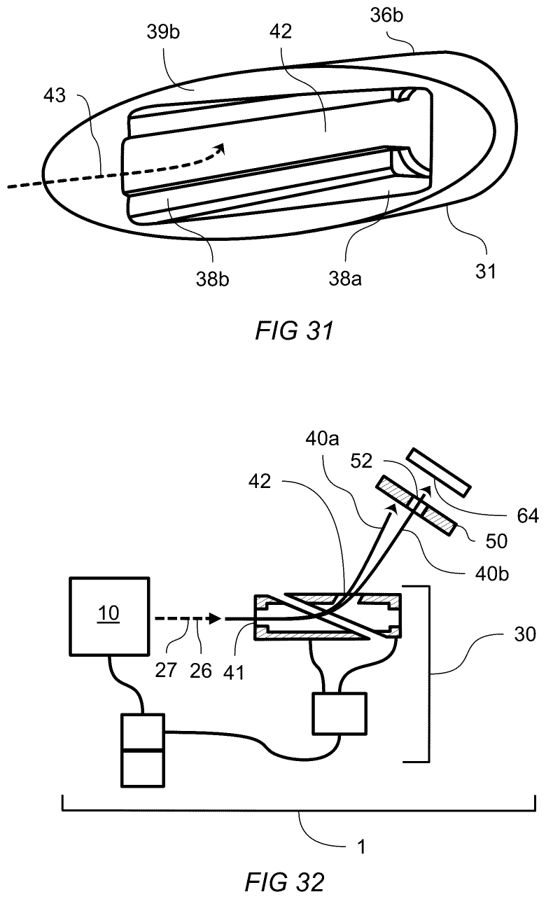

Turning now to FIG. 5, shown is perspective view of a second deflection electrode 36b which has physical features that are complementary to said first deflection electrode. Second deflection electrode 36b is shown comprising: elongate electrode body 31 extending in the direction of initial path 27 along which sample ions may travel; a deflected ion exit region 42 through which a deflected ion traveling along deflected ion path 43 or a plurality of deflected ions may exit the pulsed ion prism; a first planar inner surface 38a extending parallel to said initial path 27; a second planar inner surface 38b extending parallel to said initial path 27; said first and second planar inner surfaces intersecting at about a 90 degree angle; both first and second planar inner surfaces being part of a plurality of adjoining inner surfaces that create an open conduit suitable for ions to travel through without impediment; a second planar boundary surface 39b that is disposed at a non-90 degree angle with respect to said initial path, said second planar boundary surface terminating the plurality of inner boundary surfaces. In an alternate embodiment of second deflection electrode 36b, shown in FIG. 31, deflected ion exit region 42 may be an elongated slit that extends along the length of elongate electrode body 31.

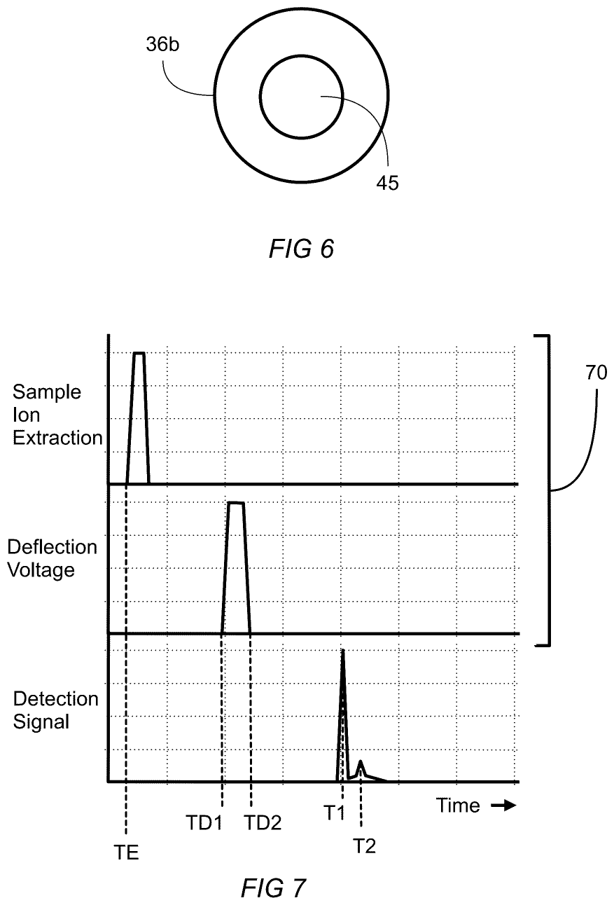

FIG. 6 is a rear elevation view of the second deflection electrode 36b of FIG. 5 in which a non-deflected ion exit region 45 is shown as a circular aperture that allows a plurality of non-deflected ions to travel out of the pulsed ion prism.

In preferred embodiments, and in accord with FIG. 1 through FIG. 6, collectively, first deflection electrode 36a and second deflection electrode 36b may be configured so that: a uniform spatial gap is maintained between first planar boundary surface 39a and second planar boundary surface 39b; the first planar inner surface 38a of first deflection electrode 36a is aligned so that it is co-planar with the first planar inner surface 38a of the second deflection electrode 36b; and, the second planar inner surface 38b of first deflection electrode 36a is aligned so that it is co-planar with the second planar inner surface 38b of the second deflection electrode 36b.

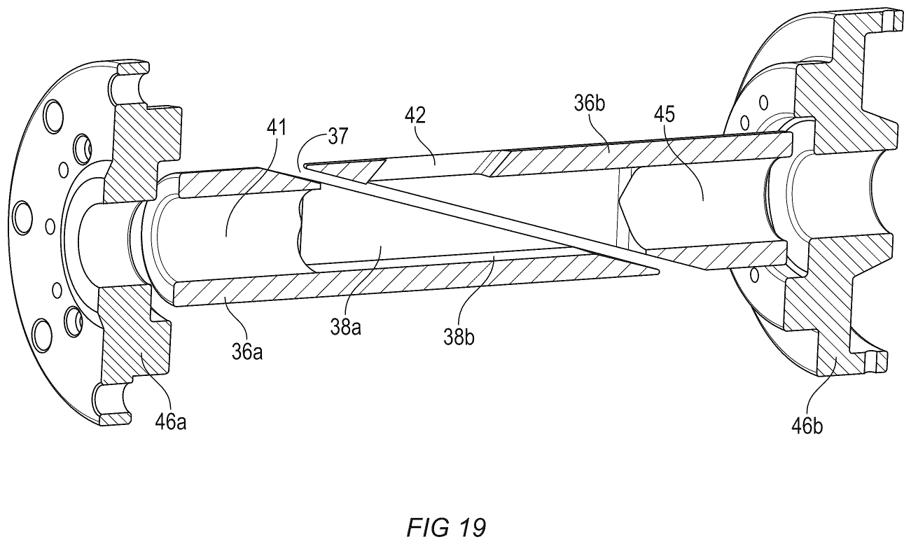

FIG. 19 shows a cross section view of a practical implementation of deflection electrodes for use in pulsed ion prisms of the present disclosure. Shown in the figure are: first and second flanges 46a and 46b, respectively; first and second deflection electrodes 36a and 36b, respectively; sample ion entry region 41; deflected ion exit region 42; non-deflected ion exit region 45; and, first and second planar electrode surfaces 38a and 38b, respectively. In preferred embodiments, an insulator may be interposed between each flange and the deflection electrode adjacent to it. The design embodied in FIG. 19 shows a uniform minimum spatial gap 37 between first and second deflection electrodes. Thus, it can be seen that pulsed ion prisms of the present disclosure may be readily integrated into ion analysis equipment and instrumentation.

Turning now to FIG. 7, shown is a graphical representation of a defined schedule 70 for operating a pulsed ion prism according to certain preferred embodiments of the present disclosure. FIG. 7 also shows a graphical representation of a detection signal recorded at the detector after operating the pulsed ion prism on a plurality of extracted sample ions, where the height of the signal is proportional to the number of ions detected and the time is the time of arrival of the ions at the detector.

The defined schedule 70 of FIG. 7 shows the steps: commence ion extraction at time TE; switch deflection controller operation to energized mode at time TD1; switch deflection controller operation to de-energized mode at time TD2. After time TD1, deflected ions will travel on the deflected-ion path towards a detector. The detection signal graph of FIG. 7 shows an exemplary ion detection data acquisition, showing a detection signal peak at time T1, and another detection signal peak T2. Each peak in the detection signal is related to a group of ions having a particular mass-to-charge ratio and that arrive at different locations on the detector surface.

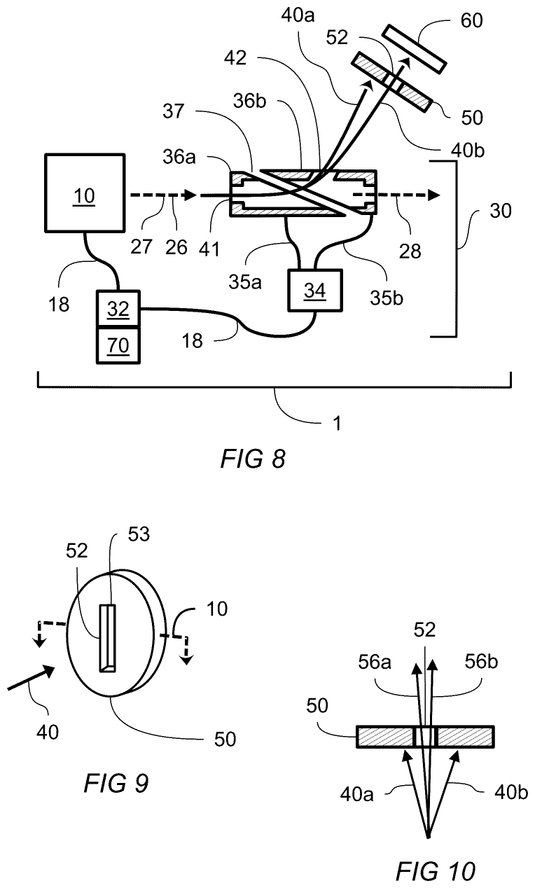

Turning now to FIG. 8, shown is a schematic view of mass spectrometry system 1 according to a preferred embodiment of the disclosure. Mass spectrometry system 1 of FIG. 8 comprises: ion extraction module 10 configured to ionize a portion of a specimen in the form of ion pulses thereby creating specimen ions, thereafter an electric field accelerates at least a portion of said specimen ions thereby creating a plurality of sample ions 26 having a range of mass-to-charge ratios and traveling along initial path 27; pulsed ion prism 30 receiving at least a portion of said plurality of sample ions through sample ion entry region 41, said pulsed ion prism 30 operating on said plurality of sample ions to create a plurality of deflected ions, 40a and 40b, which exit said pulsed ion prism 30 through a deflected ion exit region 42; a selection stage 50 disposed to receive at least a portion of said deflected ions, selection stage 50 having a selection aperture 52 configured to allow a portion of the deflected ions to pass through the selection aperture thereby becoming a plurality of selected ions; an ion detector 60 disposed to receive and detect at least a portion of said plurality of selected ions thereby defining a plurality of detected ions, detector 60 being further operative to record arrival times of said plurality of detected ions and other data that may be useful in the determination of mass-to-charge ratios for said plurality of detected ions.

With continuing reference to FIG. 8, each deflected ion exiting through said deflected ion exit region 42 may be characterized as having acquired a deflection angle through the action of said pulsed ion prism 30 in which the deflection angle is in an inverse proportional relationship with the mass-to-charge ratio of each deflected ion, said inverse proportional relationship being further characterized in that smaller mass-to-charge ratio ions are deflected less with respect to said initial path than larger mass-to-charge ratio ions. Consequently, a first deflected ion 40a, having a larger mass-to-charge ratio, will exit the deflected ion exit region with a larger deflection angle (with respect to said initial path), and a second deflected ion 40b, having a smaller mass-to-charge ratio, will exit the deflected ion exit region with a smaller deflection angle. In preferred embodiments, the pulsed ion prism 30 may be operated so that only a portion of sample ions will become deflected ions, the remainder thereby becoming a plurality of non-deflected ions 28 which may exit the pulsed ion prism 30 through a non-deflected ion exit region.

Continuing with FIG. 8, pulsed ion prism 30 is effective for inducing an angular dispersion in the plurality of deflected ions that is in relation to the mass-to-charge ratio for each deflected ion. Pulsed ion prism 30 comprises: a first deflection electrode 36a that receives at least a portion of the sample ions through sample ion entry region 41; a second deflection electrode 36b that is disposed to maintain spatial gap 37 between said first and said second deflection electrode, at least a portion of said spatial gap extending in a direction that is non-orthogonal to said initial path, said second deflection electrode 36b comprising a deflected ion exit region 42. Both deflection electrodes 36a and 36b are operatively connected to multi-channel high voltage source 34 to supply configurable first voltage 35a to said first deflection electrode 36a, and to supply configurable second voltage 35b to said second deflection electrode 36b. When first voltage 35a is not equal to second voltage 35b, an electric field is created in the immediate vicinity of said spatial gap that is operative to deflect the paths of ions that traverse any portion of said electric field. Deflection controller 32 is in communication with both ion extraction module 10 and multi-channel high voltage source 34 through communication channels 18 and is thereby operative to coordinate ion extraction operation with operation of the pulsed ion prism 30.

Continuing with FIG. 8, deflection controller 32 may operate according to defined schedule 70, which specifies the time course and magnitude of first voltage 35 and second voltage 35b, in coordination with the commencement of extraction of specimen ions by ion extraction module 10, thereby creating sample ions. Deflection controller 32 may be further configured to provide: an energized mode in which said first voltage is different from said second voltage; a de-energized mode in which said first voltage is about equal to said second voltage; and, to switch from said de-energized mode to said energized mode according to defined schedule 70. Deflection controller 32 may thereby operate the pulsed ion prism 30 so that a desired subset of sample ions is deflected, which effectively enables the selection and deflection of a subset of the range of mass-to-charge ratio ions present in the plurality of sample ions. Said desired subset of sample ions may be selected by adjusting the timing of the operation of the pulsed ion prism to match the arrival of said desired subset of sample ions to the vicinity of the spatial gap. Deflection of said desired subset of sample ions may be accomplished by pulsing, at a time corresponding to the arrival of the desired subset of sample ions in the vicinity of said spatial gap, a voltage differential between first voltage 35a and second voltage 35b, which thereby energizes said first and said second deflection electrodes 36a and 36b, creating an electric field, or deflection field for the duration of the pulsed voltage differential. It is clear from the foregoing description that defined schedule 70 may be adjusted to select any subset of mass-to-charge ratio ions present in the plurality of sample ions.

FIG. 9 shows a perspective view of a deflected ion 40 approaching a selection stage 50 having a selection aperture 52 consistent with the system of FIG. 8. FIG. 10 shows a cross sectional view of the selection stage of FIG. 9. In certain preferred embodiments of the selection aperture, the selection aperture width 53 may be narrow in the direction along which the angular dispersion in deflection angle is induced by the pulsed ion prism. A narrow selection aperture consequently permits a narrow range of deflection angles to pass through the aperture. FIG. 10, shown as a cross sectional view, illustrates that first and second deflected ions, 40a and 40b respectively, may be blocked by selection stage 50, while first and second selected ions, 56a and 56b respectively, may pass through said selection stage through selection aperture 52.

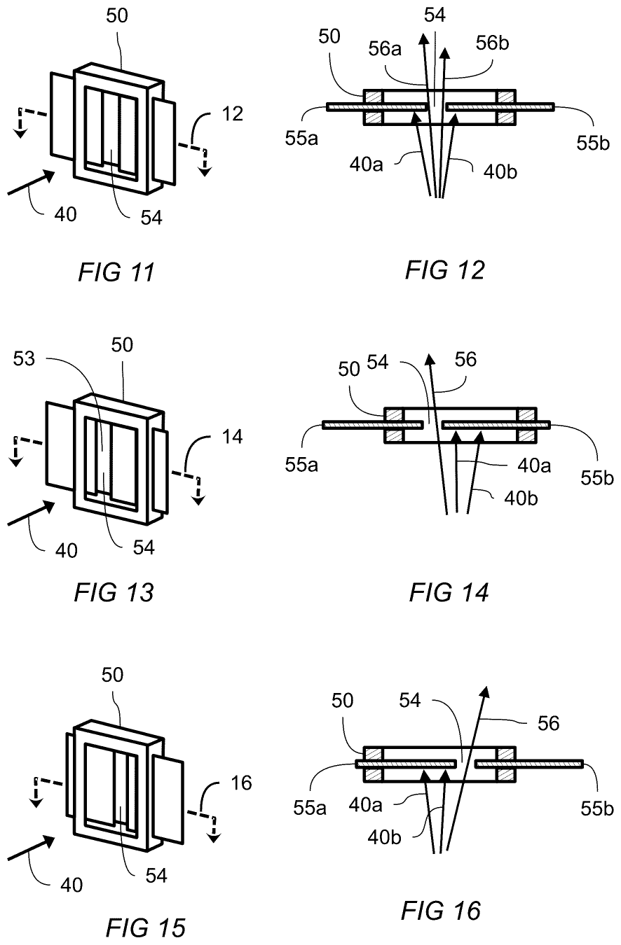

Turning now to FIG. 11-FIG. 16, shown are embodiments of configurable selection stages in which the position and the width of each selection aperture may be configurable to desired positions and widths, respectively. As a consequence of a configurable selection stage, desired ranges of deflection angles may be selected from a plurality of deflected ions, the selected range of deflection angles becoming selected ions while the selection stage is effective for blocking those deflected ions that arrive with deflection angles outside of the selected range. Now with respect to FIG. 11 and FIG. 12, shown is an exemplary embodiment of selection stage 50 having an adjustable selection aperture 54, deflected ion 40 shown approaching the selection stage. A cross-section view of FIG. 11 is the indicated FIG. 12. FIG. 12 shows an adjustable selection aperture 54 comprising: a first and a second adjustable aperture blade, 55a and 55b respectively, configured collectively to create said adjustable selection aperture. As indicated in FIG. 12, adjustable selection aperture 54 is effective to block both first and second deflected ions, 40a and 40b, respectively, while allowing first and second selected ions 56a and 56b, respectively, to pass through the selection stage. In certain preferred embodiments, first and second adjustable aperture blades 55a and 55b may be coupled to a controllable positioning mechanism so that both the position and width of the selection aperture may be set according to the mass-to-charge range of ions that are desired to be received at the detector.

FIG. 13 and its cross-sectional view FIG. 14 show a selection stage 50 comprising an adjustable selection aperture 54 having an aperture width 53, with deflected ion 40 approaching, the selection aperture having been configured such that the selection aperture is disposed in a different location as compared to the embodiment of FIG. 11 and FIG. 12. It can be understood that the selection aperture width 53 may also be adjusted. As indicated in FIG. 14, adjustable selection aperture 54, which comprises first and second adjustable aperture blades 55a and 55b, is effective to block both first and second deflected ions, 40a and 40b, respectively, while allowing selected ion 56 to pass through the selection stage.

FIG. 15 and its cross-sectional view FIG. 16 show a selection stage 50 comprising an adjustable selection aperture 54, with deflected ion 40 approaching, the selection aperture having been configured such that the selection aperture is disposed in a different location as compared to the embodiments of FIG. 12 and FIG. 14. It can be understood that the selection aperture width may also be adjusted. As indicated in FIG. 16, adjustable selection aperture 54, which comprises first and second adjustable aperture blades 55a and 55b, is effective to block both first and second deflected ions, 40a and 40b, respectively, while allowing selected ion 56 to pass through the selection stage.

It can be understood, with respect to figures FIG. 11-FIG. 16, that certain beneficial capabilities and methods are made available by the use of an adjustable selection aperture. A narrow aperture may be used to select a narrow range of mass-to-charge-ratio ions and ion kinetic energies, and the selected ions may lead to an improved mass resolving power as compared to a wide selection aperture. Furthermore, deflected ions may be systematically swept across a narrow aperture in a stepwise fashion through a sequence of aperture positions or deflections of the ion beam. In preferred embodiments, an equal number of pulses of sample ions may be generated for each selection aperture position and the selection aperture may be adjusted between pulses of sample ions. Detector data may be acquired at each position of the adjustable selection aperture. Accumulated data across a plurality of aperture positions may thereafter be fused into one or more mass spectrograms, each having a very high mass resolving power across a range of mass-to-charge ratio ions.

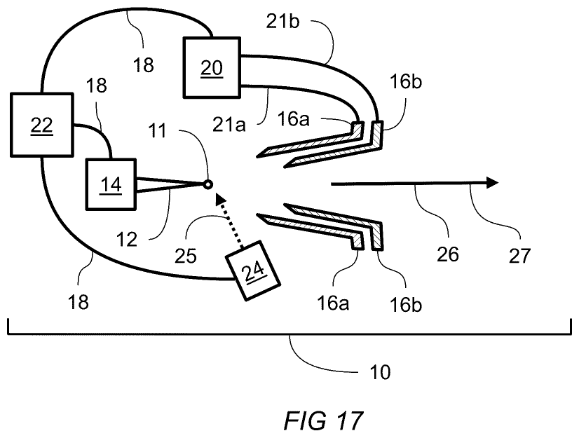

Turning now to FIG. 17, shown is a schematic view of an ion extraction module for use with various embodiments of the present disclosure. Ion extraction module 10 is shown comprising: specimen 11 held by specimen holder 12, said specimen and said specimen holder positioned by positioning stage 14; laser source 24 disposed and directed so that, when said laser source is energized, laser light 25 illuminates a portion of specimen 11; a plurality of extraction electrodes 16a and 16b operatively coupled to a multichannel high voltage source 20, the plurality of extraction electrodes operative, when energized by first voltage 21a and second voltage 21b relative to the sample, to accelerate positively charged plurality of sample ions 26 in the direction of initial path 27 of extracted ions; ion extraction controller 22, in communication with said positioning stage 14, said laser source, and said multi-channel high voltage source via communication channels 18, is operable to create a controlled stream or pulse of sample ions leaving the ion extraction module along initial path 27 of extracted ions.

In preferred embodiments of ion extraction modules of the present disclosure it may be desirable to pulse the laser source to stimulate the release of sample ions and energize the extraction electrodes according to a defined time schedule that may be initiated by or otherwise indexed to the start of the laser pulse. An electric field generated by the extraction electrodes applies a force to individual ions in proportion to the charge on each ion. Upon exiting the ion extraction module the extracted sample ions may be expected to be ordered in space according to their mass-to-charge ratio. Those ions with the lowest mass-to-charge ratio travel the fastest and exit the ion extraction module first, while those ions with the highest mass-to-charge ratio travel the slowest and exit the ion extraction module last. The ordering of ions by mass-to-charge ratio is not perfect as there are a number of sources of variability in: the release of ions from the specimen; the acceleration of ions by the action of the electric field created by the plurality of extraction electrodes; the path lengths traveled by different ions; and, the effects of mutual repulsion on the movement of sample ions having the same polarity of charge. In preferred embodiments the duration of a laser pulse is brief so as to reduce the variation in time at which an ion is released from the specimen.

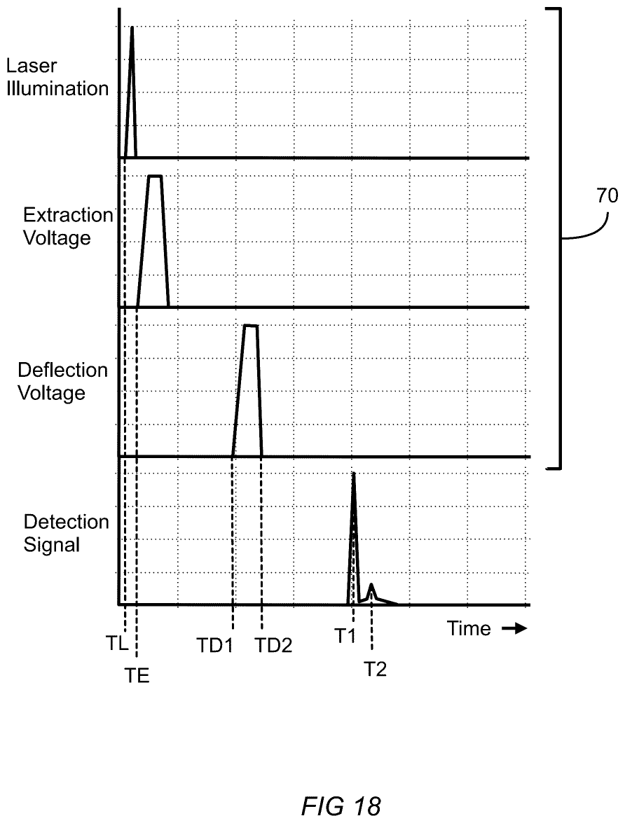

Turning now to FIG. 18, shown is a graphical representation of a defined schedule for operating a mass spectrometry system according to preferred embodiments of the present disclosure. FIG. 18 also shows a graphical representation of a detection signal recorded at the detector after operating the pulsed ion prism on a plurality of extracted sample ions, where the height of the signal is proportional to the number of ions detected and the time is the time of arrival of the ions at the detector.

The defined schedule 70 of FIG. 18 shows the steps: at time TL a laser source is energized to illuminate a portion of a sample thereby starting the release of ions from the sample; at time TE the plurality of extraction electrodes is energized to accelerate sample ions released from the sample; at time TD1 deflection controller switches to operation in energized mode; at time TD2 deflection controller operation is switched to de-energized mode. After time TD1, deflected ions will travel on the deflected-ion path towards a detector. The detection signal graph of FIG. 18 shows an exemplary ion detection data acquisition, showing a detection signal peak at time T1, and another detection signal peak T2. Each peak in the detection signal is related to a group of ions having a particular mass-to-charge ratio and that arrive at different locations on the detector surface. In preferred embodiments a selection stage may be used to select sample ions having a desired range of mass-to-charge ratios.

Pulsed ion prisms of the present disclosure have been described previously as operating in a manner in which voltage differences between deflection electrodes are pulsed so as to create an electric field, or deflection field, at selected times, those fields affecting the portions of a flow of sample ions that are in the immediate vicinity of said deflection field. The intensity and shape of the resulting electric field is a function of the physical design of the plurality of deflection electrodes and of the voltage and timings of the voltages applied thereto. One may say that the deflection field thus created is a dynamic field wherein it varies in time according to a defined schedule.

In an ion prism it can be understood that deflection electrodes may be operated in a static mode wherein a voltage difference between first and second deflection electrodes may be held about constant for a duration of time. When operated in a static mode, ions traveling through the prism will be deflected inside the prism by a deflection angle that increases in proportion with increases in the voltage difference across the deflection electrodes. It follows that, in such a static mode, ions of all masses are deflected to about the same deflection angle because the voltage difference remains constant and the electric field operates on all ions, effectively directing them to the same path. Thus, a static mode is useful for directing the entire ion stream to a range of desired destinations. Operation in a static mode may be useful for many reasons including for use in the calibration of the system for later pulsed operation. In this mode, the deflection angle of ions depends on their kinetic energy. A dispersion of ions in kinetic energy thus arrives at the selection slits and said slits may therefore be used to select a limited range of ion kinetic energy. Narrowing the range of ion kinetic energies decreases the time-of-flight spread at the detector and thus improves mass resolving power. This operation thereby enables an alternate mode of operation which is energy-filtered time-of-flight mass spectrometry.

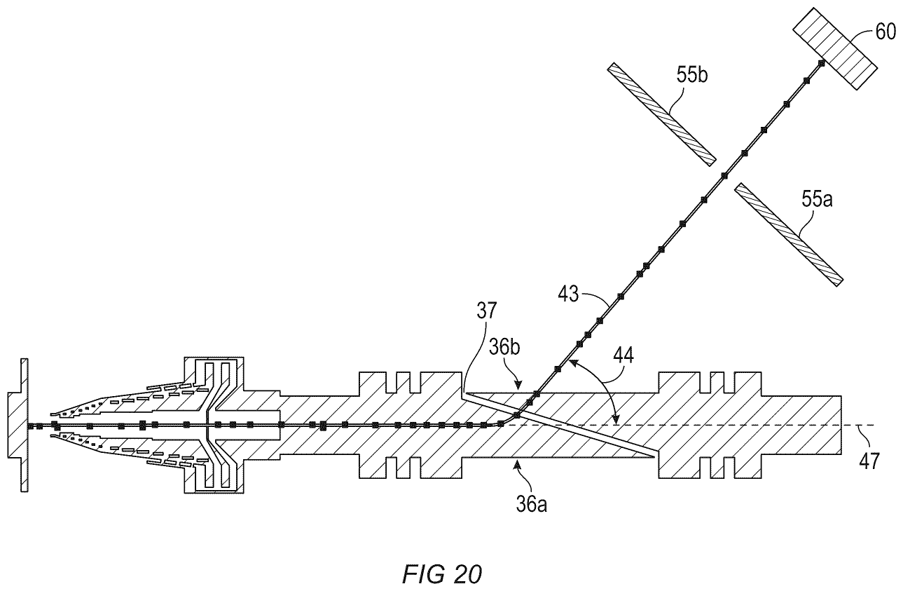

FIG. 20 shows the results of a simulation of a realized embodiment of a mass spectrometry system, which includes an ion prism, operating in a static mode. The system of FIG. 20 may be operated such that the ion beam is directed past adjustable aperture blades 55a and 55b and to the center of detector 60. The voltage difference between deflection electrodes required to deflect the ion beam to deflection angle 44 is a function of a number of design variables, including specimen voltage which influences the speed at which sample ions leave the ion extraction module. It can be understood that, when the deflection electrodes 36a and 36b, spaced apart by uniform spatial gap 37, are not energized, that a plurality of non-deflected ions 47 will travel through the ion prism without any deflection. When the deflection electrodes are energized in a static mode (meaning non-pulsed) nearly all sample ions may travel along a deflected ion flight path 43 toward detector 60. In practice, it is useful to empirically determine the ratio of specimen voltage to voltage difference between deflection electrodes that is effective to deflect the ion beam to the center and edges of detector 60. It is also useful to empirically determine the range of ratios of specimen voltage to voltage difference between deflection electrodes that allow the ion beam to pass through deflected ion exit region. These ratios are similar to, but not exactly the same, as the values that are used in pulsed angular deflection modes. The simulation of FIG. 20 was performed for a specimen potential of 10,000 volts, positively charged sample ions, electrode 36b held at 0 volts, and electrode 36a held at 7939 volts.

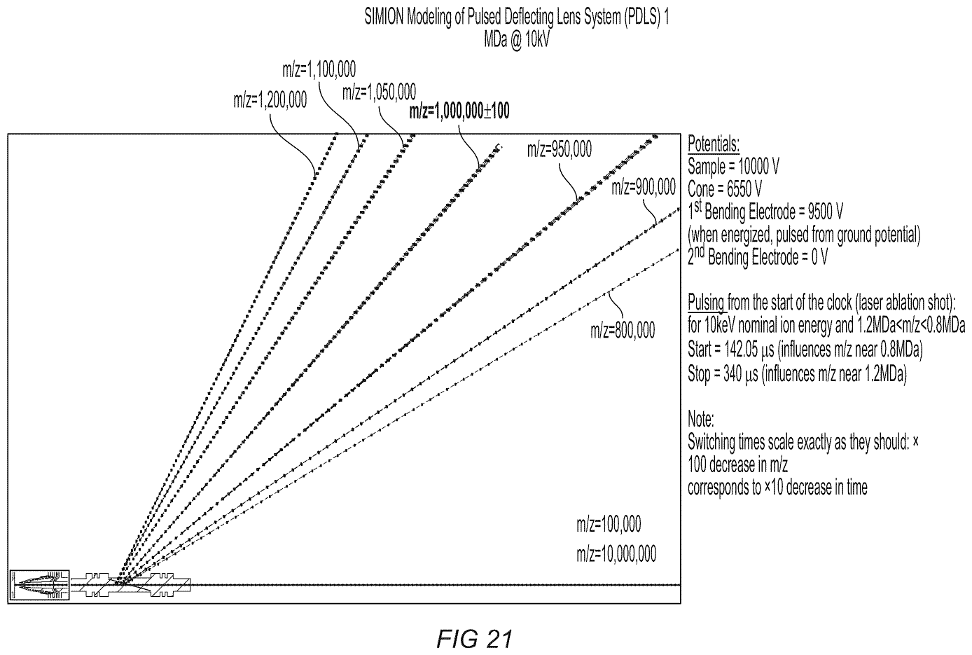

A significant advantage of a mass spectrometer using a pulsed ion prism of the present disclosure is that exceptionally large ranges of mass-to-charge ratio ions can be manipulated and analyzed by simply adjusting the timing of the operation of the prism. FIG. 21 shows the results of a simulation of ion trajectories through a mass spectrometer equipped with a pulsed ion prism. Ions with mass-to-charge number ratios selected between 800,000 and 1,200,000 are shown being deflected through the pulsed ion prism, thereby forming a dispersion of mass-to-charge number (m/z) ratios that can be further analyzed using single-channel detectors or array detectors. The simulation in FIG. 21 was performed for a specimen potential of 10,000 volts, positively charged sample ions, deflection electrode 36b held at 0 volts, deflection electrode 36a first held at 0 volts, a pulsed laser releasing ions from the sample at time TE=0 s, and at time TD1=142.05 microseconds electrode 36a is then set to 9500 volts. The times TE and TD1 can be understood in the context of FIG. 18 where they denote the results of applying the defined schedule 70 to coordinate the operation of the system.

The m/z dispersion magnification produced in this way can be much greater than those produced by distance-of-flight mass spectrometry (DOFMS) technologies. For pulsed ion prisms, the m/z dispersion magnification can be increased by moving a detector away from the prism or using deflection pulses with fast rise-times. Alternatively, m/z dispersion magnification can be reduced by moving a detector closer to the prism or using deflection pulses with slow rise-times.

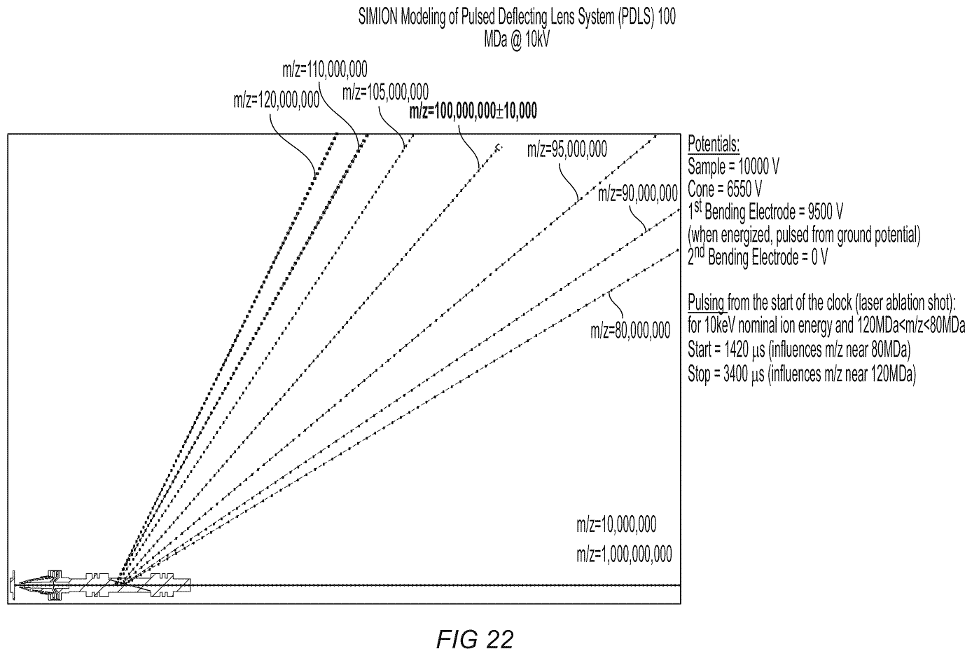

FIG. 22 shows the results of a simulation of ion trajectories through a mass spectrometer equipped with a pulsed ion prism having the same design as that of FIG. 21, but operated with a different defined schedule. The defined schedule associated with the apparatus of FIG. 21 allows ions with 100 times greater mass-to-charge number ratios to be analyzed when compared to FIG. 22. In FIG. 21, ions with mass-to-charge number ratios selected between 80,000,000 and 120,000,000 are shown being deflected through the prism and forming a dispersion of mass-to-charge number ratios that can be further analyzed using appropriate detectors. The simulation of FIG. 21 was performed for a specimen potential of 10,000 volts, positively charged sample ions, electrode 36b held at 0 volts, electrode 36a first held at 0 volts, a pulsed laser releasing ions from the sample at time=0 s, and at time=1420.5 microseconds electrode 36a is then set to 9500 volts.

In consideration of FIG. 22, FIG. 21, and the foregoing disclosure, it will be clear to those skilled in the art of mass spectrometry that the capability of analyzing such large mass-to-charge number ratios is unusual and advantageous. Conventional mass spectrometer ion optics and mass spectrometer detectors are more typically suited for mass-to-charge number ratios below about 50,000, although some spectrometers are capable of some performance at slightly larger ratios. In contrast to conventional systems, mass spectrometers based on pulsed ion prisms can, in principle, produce dispersions around any mass-to-charge number ratio. In practice, the analysis range at very high mass-to-charge number ratios may be limited by the type of detector employed. The capability of the mass spectrometry system operating with a pulsed ion prism equipped with selection aperture to deliver a selected very narrow range of very large m/z (MDa) to the detector permits more flexibility in choosing an appropriate and optimal detector. For example, for ions with such large m/z, charge-sensitive detectors (Faraday cup), and/or areal detectors (CCD/CMOS, etc.) can be successfully used instead of detectors measuring times of arrival.

Embodiments of the present disclosure may use time-of-flight measurements in both calibration and operational procedures. In these uses, time-of-flight refers to the time taken by an ion in traversing the distance between where the ion was produced at the specimen and where the ion is eventually detected at a downstream detector. It can be understood that a time of flight (TOF) may be produced knowing both the time at which an ion is produced by the ion extraction module and the time at which a detection of that ion is made, and that these capabilities are embodied by the systems and methods of the present disclosure. A detector combined with system elements for registering the arrival of ions, producing sample ions at defined times, and calculating quantities pertaining to time, together, may be jointly described as a time-of-flight detector.

In a preferred embodiment of a pulsed angular dispersion spectrometer, a time-of-flight detector is placed at a defined detector position. Under control of a defined schedule, the pulsed angular dispersion spectrometer may be configured to permit a selected range of mass-to-charge number ratios to be deflected to arrive at the detector, whilst most other mass-to-charge number ratio ions will be undeflected. In this configuration, the dispersion of mass-to-charge number ratio is kept to a minimum and timing values within the defined schedule may be selected based on the minimum and maximum mass-to-charge number ratios that are to be analyzed by the time-of-flight detector.

FIG. 23 shows calibration curves calculated for a specimen potential of 4,000 volts for the time-of-flight detector and switching times of TD1 and TD2 corresponding to defined schedule 70 of FIG. 18. Calibrations are expected to be specific to each instrument and, in practice, are calibrated empirically for best accuracy. Curve 200 shows the longest time TD1 that can be used to deflect a specific mass-to-charge number ratio (m/z). Curve 201 shows the shortest time TD2 that can be used to deflect a specific mass-to-charge number ratio. In practice a user will select a range of m/z to be analyzed on the time-of-flight detector and curves 200 and 201 can be used to calculate the timing of TD1 and TD2 for the defined schedule 70 of FIG. 18. Curve 202 shows the relationship between the time ions arrive at detector 60 as a function of m/z. It useful to note that each of curves 200, 201 and 202 have, to a first-order approximation, slopes proportional to the square root of m/z.

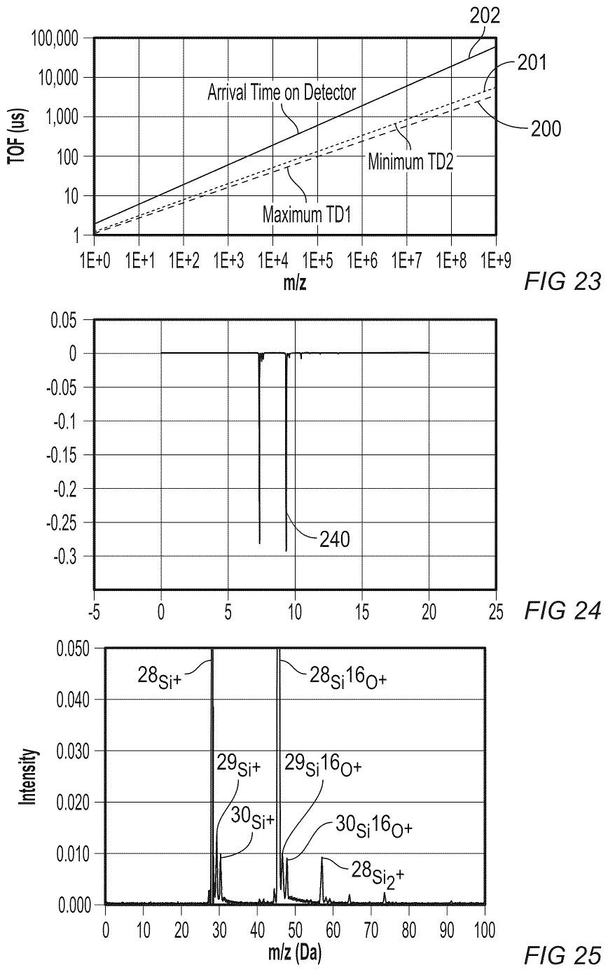

Taken together, FIG. 24, showing exemplary raw data, and FIG. 25, showing calibrated and labeled data, show the effect of applying the calibration data of FIG. 23 to raw detector data and thereby producing calibrated data that may be interpreted and graphed as a mass spectrum. FIG. 24 shows a graphical plot 240 of a statically deflected time-of-flight data sampled from a micro-channel plate (MCP) detector in defined detector position on a realized instrument. The horizontal axis is shown in microseconds and the vertical axis shows the voltage on the MCP. Peaks in the spectrum of graphical plot 240 of FIG. 24 are visible but are not calibrated in terms of mass-to-charge number ratio and as such are not directly interpretable as raw data. FIG. 25 shows this same data after it was first multiplied by −1 and then calibrated using the calibration relation embodied in curve 202 of FIG. 23. FIG. 25 also shows peak identifications made based on the calibrated time-of-flight data.

The calibration curves shown in FIG. 23 are calculated for mass-to-charge number ratios from 1 through 1,000,000,000 Da. In practice, the MCP detector used for FIG. 24 is not sensitive beyond m/z>100,000 Da. In order to detect ions with higher mass-to-charge number ratios, specialized ion velocity-independent detectors can be employed. A superconducting ion detector is one such specialized detector with demonstrated high quantum efficiency for mass-to-charge number ratios from 1 through more than 10,000,000 Da. Preferred embodiments of superconducting detectors are effective for use in time-of-flight measurements. Other preferred embodiments of superconducting detectors are effective at measuring the position of detected ions with high spatial resolution and are therefore able to detect ions with a range of deflection angles.

While superconducting ion detectors are preferred for measuring ions with m/z values greater than about 50,000 Da, in some embodiments of mass spectrometry systems of the present disclosure multiple detectors may be used to detect ions in different m/z ranges. In one such system, a superconducting detector may be used to measure higher m/z ions while the same system, by use of an appropriately designed defined schedule, may direct sample ions in a lower m/z range to a different detector such as a time-of-flight detector.

Another exemplary system of the present disclosure may place a Faraday cup detector (or an array of Faraday cups) or said areal (CMOS/CCD) detectors in the detector position to receive sample ions. Faraday cups typically do not have the signal bandwidth to be effective at time-of-flight measurements nor do they typically have sufficient sensitivity to detect single ions. They do have the advantage of being able to detect as little as tens or hundreds of ions of any mass-to-charge number ratio. Thus, a Faraday cup detector may be configured to measure ions that are far beyond the detection m/z range of MCP based detectors, including large biomolecules such as viruses. In configurations adapted to measuring large biomolecules and viruses, the defined schedule may be designed to create an angular dispersion in which only a narrow mass-to-charge number range, i.e. the range of interest, will pass through the adjustable selection aperture, whereafter selected sample ions reach the Faraday cup detector and produce a detection. Using areal CMOS/CCD detectors at wider aperture openings would enable simultaneous detection of several ions with neighboring large m/z ratios.

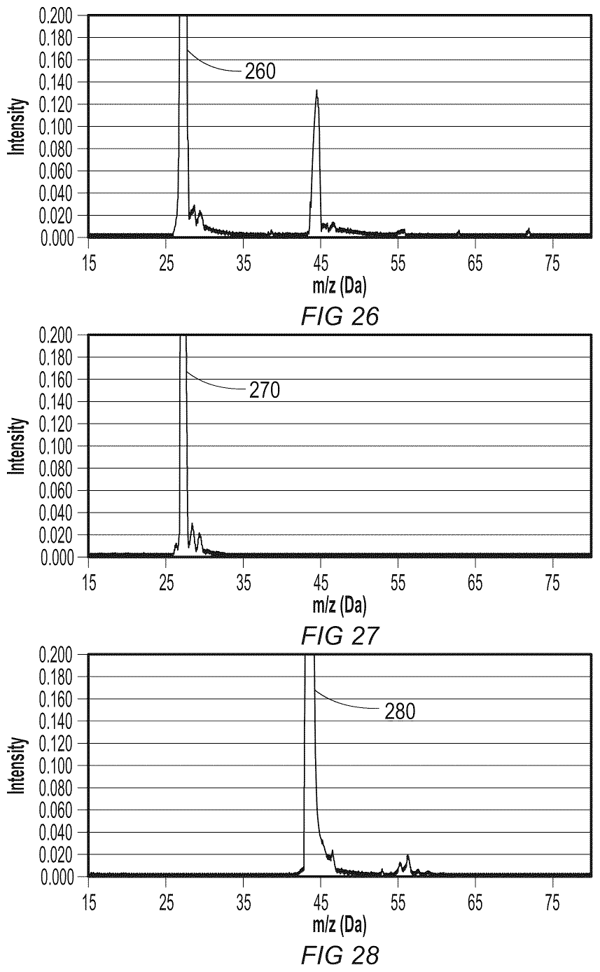

Additional embodiments of the present disclosure are operable to deflect configurable ranges of the mass spectrum onto or away from a detector positioned to receive a plurality of deflected ions, or onto or away from a detector positioned to receive a plurality of non-deflected ions. Mass spectra obtained from a realized embodiment of an angle-of-flight mass spectrometry system is shown in FIGS. 26, 27, and 28, the axes on each graph being intensity (vertical axis) and m/z (horizontal axis). The system producing the data shown in FIGS. 26, 27, and 28 is configured according to the pulsed ion prism depicted in FIG. 19. FIG. 26, showing a graphical plot of a mass spectrum 260, shows a mass spectrum covering a range from about m/z=15 to about m/z=80. While collecting this data, an adjustable selection aperture was opened to its maximum extent of about 25 mm. In FIG. 27, which shows a graphical plot of a mass spectrum 270, the defined schedule of energizing and de-energizing the deflection electrodes was adapted to allow a mass spectrum range of about m/z=25 to about m/z=35. In FIG. 28, which shows a graphical plot of a mass spectrum 280, the defined schedule was configured to allow a mass spectrum range of about m/z=40 to about m/z=65.

Further additional embodiments of the present disclosure are operable to deflect configurable ranges of the mass spectrum onto or away from a collection surface positioned to receive a plurality of deflected ions. The collection surface may thereafter be used to directly examine properties of the collected sample, for example with electron, x-ray, and/or scanned probe microscopies. The collection surface may also be used to transport the collected sample for subsequent examination with other testing equipment or to be used as a purification process for other experimental use. The collection surface may be biased to reduce the impact damage of ions arriving on the surface. The collection surface may also be made of material that will allow direct observation in a microscope, such as a carbon support film or a film of frozen water. The collection surface may also be used to transfer the collected sample into a solution which may include a solvent such as water, buffered water, or alcohol.

FIG. 32 shows a schematic view of mass spectrometry system 1 according to a preferred embodiment of the disclosure, the system being operable to collect a selected range of m/z ions from a specimen on a collection surface 64. Prior teachings of this disclosure make it clear that a high degree of control may be exerted over the m/z range of ions that travel through the selection stage 50 and onto the collection surface. The mass spectrometry system 1 of FIG. 32 comprises: ion extraction module 10 configured to ionize a portion of a specimen in the form of ion pulses thereby creating specimen ions, thereafter an electric field accelerates at least a portion of said specimen ions thereby creating a plurality of sample ions 26 having a range of mass-to-charge ratios and traveling along initial path 27; pulsed ion prism 30 receiving at least a portion of said plurality of sample ions through sample ion entry region 41, said pulsed ion prism 30 operating on said plurality of sample ions to create a plurality of deflected ions, 40a and 40b, which exit said pulsed ion prism 30 through a deflected ion exit region 42; a selection stage 50 disposed to receive at least a portion of said deflected ions, selection stage 50 having a selection aperture 52 configured to allow a portion of the deflected ions to pass through the selection aperture thereby becoming a plurality of selected ions; a collection surface 64 disposed to receive at least a portion of said plurality of selected ions thereby defining a plurality of collected ions.

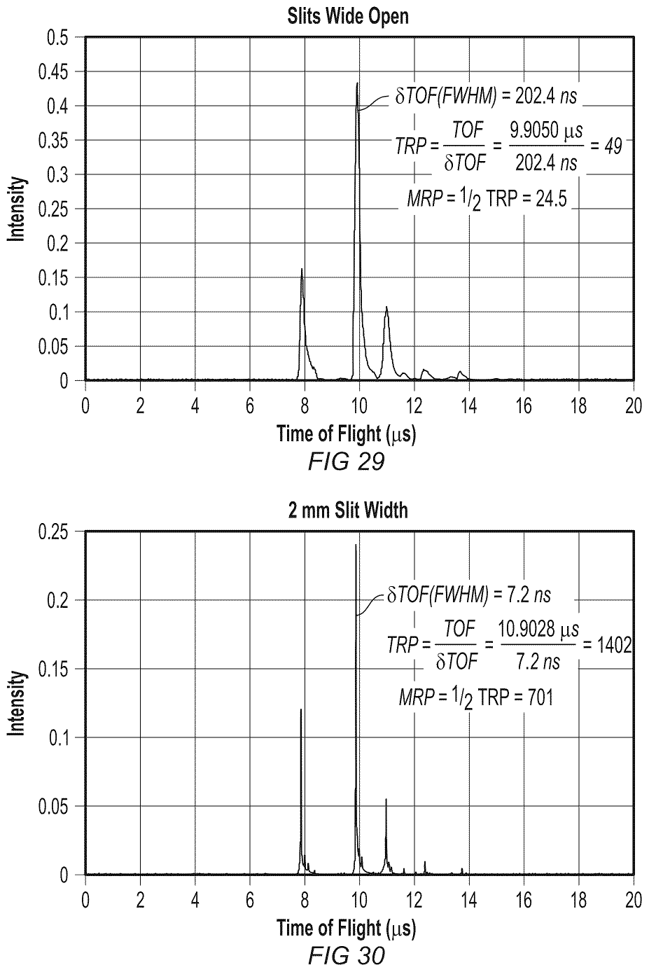

Turning now to FIG. 29 and FIG. 30, shown are two graphs plotting intensity (vertical axis) versus time-of-flight (horizontal axis) for MS embodiments of the present disclosure. FIG. 29 and FIG. 30, collectively, show the improvements available in time resolving power (TRP), and consequently mass resolving power (MRP), obtainable by static potentials on the pulsed ion prism. MRP is a common metric of mass spectrometry performance which may be estimated on a time-of-flight spectrum calibrated in flight time by dividing the time of the center of the peak by full-width half-maximum (FWHM) of a peak and dividing by 2. This calculation is shown in FIG. 29 for a spectrum acquired where the adjustable selection aperture was opened to its maximum extent (25 mm). The MRP evident in FIG. 29 for the highest peak (9.9050 microseconds) is 24.5, which is low for a typical time-of-flight mass spectrometer. It is low because the range of kinetic energy of detected ions is large with wide-open aperture, which corresponds to a wider range of times of arrival.

FIG. 30 shows a spectrum acquired where the adjustable selection aperture was nearly closed (2 mm), the MS system thereby restricting the range of kinetic energy of the selected ions to a narrow value. The MRP for the highest peak (10.0928 microseconds) is 701, which is reasonable for a TOF mass spectrometer and significantly improved with respect to MS data represented in FIG. 29. In this case, the narrower aperture narrows down the spread of kinetic energies of detected ions (and, correspondingly, the range of their times of arrival).

In a preferred embodiment of the present invention, elements 36b and 46a in FIG. 19 are at ground potential and element 36a is subjected to a controllable positive potential variation. In an alternative embodiment of the present invention, elements 36a and 36b in FIG. 19 may be subjected to a scheduled potential variation. For example, if element 46a (end electrode) is at ground potential, then element 36a (deflection electrode) may be subjected to a scheduled positive potential variation and element 36b may be subjected to a scheduled negative potential variation. The timing and duration of these scheduled potential variations can be adjusted to accomplish certain beneficial tasks. In this alternative example, time focusing of ions at the detector may be achieved for a select group of m/z ions. The dispersion in m/z may also be increased or decreased by appropriate timing of a scheduled potential variation in this latter scenario. Other effects may also be achieved by scheduled potential variations for other electrodes including element 46a. Thus, a time schedule for a potential variation of any combination of electrodes 46a, 36a, 36b, or 46b could be engineered to beneficial effect.

Turning now to FIG. 31, shown is an alternate embodiment of second deflection electrode 36b which has physical features that are complementary to the first deflection electrode. Second deflection electrode 36b is shown comprising: elongate electrode body 31 extending in the direction of initial path along which sample ions may travel; a deflected ion exit region 42 through which a deflected ion may travel along deflected ion flight path 43 or a plurality of deflected ions may exit the pulsed ion prism; a first planar inner surface 38a extending parallel to said initial path; a second planar inner surface 38b extending parallel to said initial path; said first and second planar inner surfaces intersecting at about a 90 degree angle; both first and second planar inner surfaces being part of a plurality of adjoining inner surfaces that create an open conduit suitable for ions to travel through without impediment; a planar boundary surface 39b that is disposed at a non-90 degree angle with respect to said initial path, said second planar boundary surface terminating the plurality of inner boundary surfaces.

Any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

What is claimed is:

1. A mass spectrometry system for characterizing a specimen, the system comprising:
A. an ion extraction module operable to create a plurality of sample ions traveling along an initial path, the ion extraction module operating in coordination with an extraction controller to create a plurality of ion pulses from said specimen, each of said ion pulses comprising a plurality of sample ions; each of said ions pulses having an ion extraction start time that corresponds to the time at which the creation of said ion pulse begins; said plurality of sample ions in each of said ion pulses having a range of mass-to-charge ratios and having the property that each sample ion has a speed in a proportional relationship to the mass-to-charge ratio of each sample ion, said proportional relationship characterized in that lower mass-to-charge ratio ions travel faster along said initial ion path;
B. a pulsed ion prism configured to receive said sample ions traveling along said initial path, the pulsed ion prism comprising:
i. a first deflection electrode energized by a first voltage;
ii. a second deflection electrode energized by a second voltage and spaced apart from said first deflection electrode by a spatial gap, the spatial gap defining a minimum distance between said first and said second electrodes, at least a portion of the spatial gap extending in a direction that is not parallel to said initial path;
iii. said first deflection electrode and said second deflection electrode further configured in that, when said first voltage is not equal to said second voltage, an electric field is created between said first and said second deflection electrodes; said electric field operable to deflect, by a deflection angle, at least a portion of said plurality of sample ions away from said initial path, across said spatial gap, and onto a plurality of deflected paths that are not parallel to said initial path;
C. a deflection controller operable to apply said first voltage to said first deflection electrode and to apply said second voltage to said second deflection electrode, the deflection controller being further operable to:
i. provide a deflecting mode in which said first voltage is changed with respect to said second voltage, the difference between said first voltage and said second voltage defining a voltage differential, said voltage differential affecting said deflection angle such that:
a. larger said voltage differential results in larger deflection angle of any deflected ion;
b. smaller said voltage differential results in smaller deflection angle of any deflected ion;
ii. said deflecting mode further characterized in that said deflecting mode creates a plurality of deflected ions, each deflected ion having a non-zero deflection angle that is in a proportional relationship to the mass-to-charge ratio of each deflected ion in that lower mass-to-charge ratio corresponds to smaller deflection angle; at least a portion of said plurality of deflected ions exiting the pulsed ion prism through a deflected ion exit region.

2. The system of claim 1 further characterized in that:
A. the deflection controller is further operable to engage and dis-engage said deflection mode according to a defined schedule; and,
B. operating the system according to said defined schedule results in said deflected ions having a range of mass-to-charge ratios that is a subset of said range of mass-to-charge ratios present in said plurality of sample ions.

3. The system of claim 1 further characterized in that:
A. the first deflection electrode further comprises:
i. an elongate electrode body extending in the same direction as said initial path;
ii. a first planar inner surface extending parallel to said initial path;
iii. a second planar inner surface extending parallel to said initial path;
iv. said first planar inner surface and said second planar inner surface intersecting at an angle of about 90 degrees;
v. a first planar boundary surface that is disposed at a boundary angle with respect to said initial path, said boundary angle being not parallel to said initial path;
B. the second deflection electrode further comprises:
i. an elongate electrode body extending in the same direction as said initial path;
ii. a first planar inner surface extending parallel to said initial path;
iii. a second planar inner surface extending parallel to said initial path;
iv. said first planar inner surface and said second planar inner surface intersecting at an angle of about 90 degrees;
v. a second planar boundary surface that is spaced away from said first planar boundary surface by said spatial gap;
C. said first deflection electrode and said second deflection electrode being further configured in that:
i. said first inner surface of said first deflection electrode is disposed parallel to said first inner surface of said second deflection electrode; and,
ii. said second inner surface of said first deflection electrode is disposed parallel to said second inner surface of said second deflection electrode;
D. at least a portion of said second deflection electrode forming at least a portion of said
deflected ion exit region.

4. The system of claim 1 further comprising
A. a selection aperture disposed to receive at least of portion of said plurality of deflected ions;
B. said selection aperture operative to allow at least a portion of said plurality of deflected ions to pass through said selection aperture, thereby creating a plurality of selected ions traveling beyond said selection aperture;
C. said selection aperture operative to block at least a portion of said plurality of deflected ions thereby creating a plurality of blocked ions, said plurality of blocked ions not traveling beyond said selection aperture.

5. The system of claim 1, the selection aperture further comprising:
an aperture width that is operable to allow the plurality of selected ions to have a range of mass-to-charge ratios, said range having a proportionality to said aperture width in that larger aperture width allows a larger range of mass-to-charge ratios to pass through said selection aperture.

6. The system of claim 1, the selection aperture further comprising:
a configurable aperture that is operable in at least two different aperture positions, each aperture position allowing at least a portion of said plurality of deflected ions to pass through said selection aperture, each aperture position allowing a range of mass-to-charge ratio ions to pass through said selection aperture where different aperture positions select different ranges of mass-to-charge ratio to pass through said selection aperture.

7. The system of claim 1, the selection aperture further characterized in that it has a configurable aperture width that allows at least two different aperture widths, each different aperture width allowing a different range of mass-to-charge ratio ions to pass through said selection aperture.

8. The system of claim 1 further comprising a detector disposed to receive and detect at least a portion of said plurality of deflected ions exiting said pulsed ion prism.

9. The system of claim 8 wherein the detector uses a Faraday cup and is operable to detect ions having mass-to-charge number ratios greater than about 100,000.

10. The system of claim 8 wherein the detector uses a superconducting detector and is operable to detect ions having mass-to-charge number ratios greater than about 100,000.

11. The system of claim 1 further comprising a sample collection surface disposed to receive at least a portion of said plurality of deflected ions.

12. A mass spectrometry system operating on a plurality of sample ions having a range of mass-to-charge ratios, said sample ions traveling along an initial path, the system comprising:
A. A pulsed ion prism configured to receive said sample ions traveling along said initial path, the pulsed ion prism comprising:
i. a first deflection electrode energized by a first voltage;
ii. a second deflection electrode energized by a second voltage and spaced apart from said first deflection electrode by a spatial gap, the spatial gap defining a minimum distance between said first and said second electrodes, at least a portion of the spatial gap extending in a direction that is not parallel to said initial path;
iii. said first deflection electrode and said second deflection electrode further configured in that, when said first voltage is not equal to said second voltage, an electric field is created between said first and said second deflection electrodes; said electric field operable to deflect, by a deflection angle, at least a portion of said plurality of sample ions away from said initial path, across said spatial gap, and onto a plurality of deflected paths that are not parallel to said initial path;
B. a deflection controller operable to apply said first voltage to said first deflection electrode and to apply said second voltage to said second deflection electrode, the deflection controller being further operable to:
i. provide a deflecting mode in which said first voltage is changed with respect to said second voltage, the difference between said first voltage and said second voltage defining a voltage differential, said voltage differential affecting said deflection angle such that:
a. larger said voltage differential results in larger said deflection angle of any deflected ion;
b. smaller said voltage differential results in smaller said deflection angle of any deflected ion;
ii. said deflecting mode further characterized in that said deflecting mode creates a plurality of deflected ions, each deflected ion having a non-zero deflection angle that is in a proportional relationship to the mass-to-charge ratio of each deflected ion in that lower mass-to-charge ratio corresponds to smaller deflection angle; at least a portion of said plurality of deflected ions exiting the pulsed ion prism through a deflected ion exit region.

13. The system of claim 12 further characterized in that:
A. the deflection controller is further operable to engage and dis-engage said deflecting mode according to a defined schedule; and,
B. operating according to said defined schedule results in said deflected ions having a range of mass-to-charge ratios that is a subset of said range of mass-to-charge ratios present in said plurality of sample ions.

14. The system of claim 12 further characterized in that:
A. the first deflection electrode further comprises:
i. an elongate electrode body extending in the same direction as said initial path;
ii. a first planar inner surface extending parallel to said initial path;
iii. a second planar inner surface extending parallel to said initial path;
iv. said first planar inner surface and said second planar inner surface intersecting at an angle of about 90 degrees;
v. a first planar boundary surface that is disposed at a boundary angle with respect to said initial path, said boundary angle being not parallel to said initial path;
B. the second deflection electrode further comprises:
i. an elongate electrode body extending in the same direction as said initial path;
ii. a first planar inner surface extending parallel to said initial path;
iii. a second planar inner surface extending parallel to said initial path;
iv. said first planar inner surface and said second planar inner surface intersecting at an angle of about 90 degrees;
v. a second planar boundary surface that is spaced away from said first planar boundary surface by said spatial gap;
C. said first deflection electrode and said second deflection electrode being further configured in that:
i. said first inner surface of said first deflection electrode is disposed parallel to said first inner surface of said second deflection electrode; and,
ii. said second inner surface of said first deflection electrode is disposed parallel to said second inner surface of said second deflection electrode;
D. at least a portion of said second deflection electrode forming at least a portion of said deflected ion exit region.

15. The system of claim 12 further comprising
A. a selection aperture disposed to receive at least a portion of said plurality of deflected ions;
B. said selection aperture operative to allow at least a portion of said plurality of deflected ions to pass through said selection aperture, thereby creating a plurality of selected ions traveling beyond said selection aperture;
C. said selection aperture operative to block at least a portion of said plurality of deflected ions thereby creating a plurality of blocked ions, said plurality of blocked ions not traveling beyond said selection aperture.

16. The system of claim 15, the selection aperture further comprising:
A. an aperture width that is operable to allow the plurality of selected ions to have a range of mass-to-charge ratios, said range having a proportionality to said aperture width in that larger aperture width allows larger range of mass-to-charge ratios to pass through said selection aperture.

17. The system of claim 15, the selection aperture further comprising:
A. a configurable aperture that is operable in at least two different aperture positions, each aperture position allowing at least a portion of said plurality of deflected ions to pass through said selection aperture, each aperture position allowing a range of mass-to-charge ratio ions to pass through said selection aperture where different aperture positions select different ranges of mass-to-charge ratio to pass through said selection aperture.

18. The system of claim 15, the selection aperture further characterized in that it has a configurable aperture width that allows at least two different aperture widths, each different aperture width allowing a different range of mass-to-charge ratio ions to pass through said selection aperture.

19. The system of claim 12 further comprising a detector disposed to receive and detect at least a portion of said plurality of deflected ions exiting said pulsed ion prism.

20. The system of claim 19 wherein the detector uses a Faraday cup and is operable to detect ions having mass-to-charge number ratios greater than about 100,000.

21. The system of claim 19 wherein the detector uses a superconducting detector and is operable to detect ions having mass-to-charge number ratios greater than about 100,000.

22. The system of claim 12 further comprising a sample collection surface disposed to receive at least a portion of said plurality of deflected ions.

23. A method of operating on a plurality of sample ions having a variety of mass-to-charge ratios, the plurality of sample ions traveling along an initial path, the method comprising the steps of:
A. receiving said plurality of sample ions in a pulsed ion prism, the pulsed ion prism comprising a first deflection electrode and a second deflection electrode;
B. spacing said first deflection electrode away from said second deflection electrode by a spatial gap, the spatial gap defining a minimum distance between said first and said second deflection electrodes, at least a portion of the spatial gap extending in a direction that is not parallel to said initial path;
C. configuring a deflection controller to apply a first voltage to said first deflection electrode and to apply a second voltage to said second deflection electrode,
D. providing in said deflection controller a deflecting mode in which said first voltage is changed with respect to said second voltage, said energized mode creating an electric field between said first and said second deflection electrodes, said electric field being operative to deflect at least a portion of said sample ions away from said initial path, across said spatial gap, and onto a plurality of deflected paths that are not parallel to said initial path;
E. engaging said deflecting mode when a portion of said sample ions is in close proximity to said spatial gap thereby creating a plurality of deflected ions that are deflected away from said initial path, each deflected ion having a deflection angle that is in a proportional relationship to the mass-to-charge ratio of each deflected ion such that lower mass-to-charge ratio corresponds to smaller deflection angle.

24. The method of claim 23 further comprising the steps of:
A. positioning a selection aperture to receive at least a portion of said plurality of deflected ions:
i. the selection aperture allowing at least a portion of said plurality of deflected ions to pass through said selection aperture thereby creating a plurality of selected ions, said plurality of selected ions traveling beyond said selection aperture;
ii. the selection aperture blocking at least a portion of said plurality of deflected ions thereby creating a plurality of blocked ions, said plurality of blocked ions not travelling beyond said selection aperture.

25. The method of claim 23 further comprising the steps of:
A. positioning a selection aperture having a configurable aperture width to receive at least a portion of said plurality of deflected ions:
i. the selection aperture allowing at least a portion of said plurality of deflected ions to pass through said selection aperture thereby creating a plurality of selected ions, said plurality of selected ions traveling beyond said selection aperture;
ii. the selection aperture blocking at least a portion of said plurality of deflected ions thereby creating a plurality of blocked ions, said plurality of blocked ions not travelling beyond said selection aperture;
B. configuring said aperture width to allow the plurality of selected ions to have a range of mass-to-charge ratios, said range having a proportionality to said aperture width in that larger aperture width allows larger range of mass-to-charge ratios to pass through said selection aperture.

26. The method of claim 23 further comprising the steps of:
A. disposing an ion detector to receive at least a portion of said plurality of deflected ions;
B. detecting at least a portion of said plurality of deflected ions in said ion detector.

27. The method of claim 26 further comprising the step of detecting in said ion detector ions having mass-to-charge number ratios greater than about 100,000.

28. The method of claim 23 further comprising the step of disposing a sample collection surface to collect at least a portion of said plurality of deflected ions.
